(19) United States
(12) Patent Application Publication
(10) Pub. No.: US 2021/0342083 A1
(43) Pub. Date: Nov. 4, 2021

(54) DATA PROCESSING SYSTEM INCLUDING PLURALITY OF MEMORY SYSTEMS

(71) Applicant: SK hynix Inc., Gyeonggi-do (KR)

(72) Inventor: Eu Joon BYUN, Gyeonggi-do (KR)

(21) Appl. No.: 17/085,908

(22) Filed: Oct. 30, 2020

(30) Foreign Application Priority Data
Apr. 29, 2020 (KR) 10-2020-0052149

(51) Int. Cl. G06F 3/06

(52) U.S. Cl. CPC G06F 3/0644; G06F 3/0679; G06F 3/0604

(57) ABSTRACT

A data processing apparatus includes a first memory system including first and second interfaces and a first storage region, coupled to a host through the first interface, and configured to set a size of logical-to-physical (L2P) mapping of the first storage region to a first size unit; and a second memory system including a third interface coupled to the second interface to communicate with the first memory system, and configured to transmit capacity information for a second storage region included therein to the first memory system according to a request of the first memory system during an initial operation period, and set a size of logical-to-physical (L2P) mapping of the second storage region to a second size unit in response to a map setting command transmitted from the first memory system during the initial operation period.

### CROSS-REFERENCE TO RELATED APPLICATION

This application claims priority under 35 U.S.C. § 119 to Korean Patent Application No. 10-2020-0052149, filed on Apr. 29, 2020, which is incorporated herein by reference in its entirety.

### BACKGROUND

### 1. Field

Various embodiments relate to a data processing system, and more particularly, to a data processing system including a plurality of memory systems and a method for operating the data processing system.

### 2. Discussion of the Related Art

Recently, a computer environment paradigm has shifted to ubiquitous computing, which enables a computer system to be accessed virtually anytime and everywhere. As a result, the use of portable electronic devices, such as mobile phones, digital cameras, notebook computers and the like, has grown. Such portable electronic devices typically use or include a memory system that includes or embeds at least one memory device, e.g., a data storage device. The data storage device can be used as a main storage device or an auxiliary storage device of a portable electronic device.

A computing device benefits from implementing data storage in the form of a nonvolatile semiconductor memory device because the device has excellent stability and durability due to the lack of a mechanical driving part (e.g., a mechanical arm in a hard disk) and can exhibit high data access speeds and low power consumption. Examples of semiconductor data storage devices include a universal serial bus (USB) memory device, a memory card having various interfaces, and/or a solid state drive (SSD).

### SUMMARY

Various embodiments are directed to a data processing system capable of effectively managing a plurality of memory systems.

In an embodiment, a data processing apparatus may include: a first memory system including first and second interfaces and a first storage region, coupled to a host through the first interface, and configured to set a size of logical-to-physical (L2P) mapping of the first storage region to a first size unit; and a second memory system including a third interface coupled to the second interface to communicate with the first memory system, and configured to transmit capacity information for a second storage region included therein to the first memory system according to a request of the first memory system during an initial operation period, and set a size of logical-to-physical (L2P) mapping of the second storage region to a second size unit in response to a map setting command transmitted from the first memory system during the initial operation period.

The first memory system may be further configured to check the capacity information for the second storage region and set the first size unit and the second size unit, which are different from each other depending on a result of the check, during the initial operation period.

The first memory system may set the first and second size units by: generating, when the second storage region is larger than or the same as the first storage region, the map setting command for setting the second size unit larger than the first size unit and transmitting the generated map setting command to the second memory system, and generating, when the first storage region is larger than the second storage region, the map setting command for setting the first size unit larger than the second size unit and transmitting the generated map setting command to the second memory system.

The first memory system may be further configured to: analyze an input command received from the host during a normal operation period after the initial operation period, select, depending on a result of the analysis, the first or second memory system to process the input command, receive, when the second memory system is selected to process the input command, a result of processing the input command from the second memory system, and transmit the result of processing the input command to the host.

When the input command is a write command, the first memory system may analyze the input command by checking a pattern of write data corresponding to the write command. When the input command is the write command, the first memory system may select the first or second memory system by storing the write data in the first or second storage region, When the input command is a read command, the first memory system may analyze the input command by checking a logical address corresponding to the read command. When the input command is the read command, the first memory system may select the first or second memory system by reading read data from the first or second storage region.

The write data smaller than a reference size may be a random pattern, and the write data larger than the reference size may be of a sequential pattern. When the second size unit is set larger than the first size unit, the first memory system may store the sequential pattern write data in the second storage region, and may store the random pattern write data in the first storage region. When the first size unit is set larger than the second size unit, the first memory system may store the sequential pattern write data in the first storage region, and may store the random pattern write data in the second storage region.

The first memory system may be further configured to: set a range of a first logical address corresponding to the first storage region and a range of a second logical address corresponding to the second storage region, which are different from each other during the initial operation period, share the second logical address with the second memory system, and share, with the host, a range of a summed logical address which is obtained by summing the ranges of the first logical address and the second logical address.

When the second size unit is set larger than the first size unit, the write data may be the sequential pattern and a first input logical address corresponding to the write command is included in the range of the second logical address, the first memory system may store the write data by transmitting the write command and the first input logical address to the second memory system to store the write data in the second storage region. When the second size unit is set larger than the first size unit, the write data may be the random pattern and the first input logical address is included in the range of the first logical address, the first memory system may store the write data in the first storage region in response to the write command and the first input logical address. When the first size unit is set larger than the second size unit, the write data may be the sequential pattern and the first input logical address is included in the range of the first logical address, the first memory system may store the write data in the first storage region in response to the write command and the first input logical address. When the first size unit is set larger than the second size unit, the write data may be the random pattern and the first input logical address is included in the range of the second logical address, the first memory system may store the write data by transmitting the write command and the first input logical address to the second memory system to store the write data in the second storage region.

When the second size unit is set larger than the first size unit, the write data may be the sequential pattern and the first input logical address is included in the range of the first logical address, the first memory system may store the write data by: managing a first intermediate logical address included in the range of the second logical address, as intermediate mapping information, by mapping the first intermediate logical address to the first input logical address, and transmitting the write command and the first intermediate logical address to the second memory system to store the write data in the second storage region. When the second size unit is set larger than the first size unit, the write data may be the random pattern and the first input logical address is included in the range of the second logical address, the first memory system stores the write data by: managing a second intermediate logical address included in the range of the first logical address, as the intermediate mapping information, by mapping the second intermediate logical address to the first input logical address, and storing the write data in the first storage region in response to the write command and the second intermediate logical address. When the first size unit is set larger than the second size unit, the write data may be the sequential pattern and the first input logical address is included in the range of the second logical address, the first memory system may store the write data by: managing a third intermediate logical address included in the range of the first logical address, as the intermediate mapping information, by mapping the third intermediate logical address to the first input logical address, and storing the write data in the first storage region in response to the write command and the third intermediate logical address. When the first size unit is set larger than the second size unit, the write data may be the random pattern and the first input logical address is included in the range of the first logical address, the first memory system may store the write data by: managing a fourth intermediate logical address included in the range of the second logical address, as the intermediate mapping information, by mapping the fourth intermediate logical address to the first input logical address, and transmitting the write command and the fourth intermediate logical address to the second memory system to store the write data in the second storage region.

In the case where a second input logical address corresponding to the read command is not detected in the intermediate mapping information, the first memory system may read the read data from the first storage region in response to the read command and the second input logical address when the second input logical address is included in the range of the first logical address, and may read the read data by transmitting the read command and the second input logical address to the second memory system to read the read data from the second storage region when the second input logical address is included in the range of the second logical address.

In the case in which a fifth intermediate logical address mapped to the second input logical address is detected by referring to the intermediate mapping information, the first memory system may read the read data by transmitting the read command and the fifth intermediate logical address to the second memory system to read the read data from the second storage region when the fifth intermediate logical address is included in the range of the second logical address, and may read the read data from the first storage region in response to the read command and the fifth intermediate logical address when the fifth intermediate logical address is included in the range of the first logical address.

The size of logical-to-physical (L2P) mapping of the first storage region may be a size of an information representing a mapping relationship between a physical address of a first storage region and the logical address. The size of logical-to-physical (L2P) mapping of the second storage region may be a size of an information representing a mapping relationship between a physical address of the second storage region and a logical address.

In an embodiment, a data processing apparatus may include: a main memory system including first to third interfaces and a main storage region, coupled to a host through the first interface, and configured to set a size of logical-to-physical (L2P) mapping of the main storage region to a reference size unit; a first sub memory system including a fourth interface coupled to the second interface to communicate with the main memory system, and configured to transmit first capacity information for a first storage region included therein to the main memory system according to a request of the main memory system during an initial operation period, and set a size of logical-to-physical (L2P) mapping of the first storage region to a first size unit in response to a first map setting command transmitted from the main memory system during the initial operation period; and a second sub memory system including a fifth interface coupled to the third interface to communicate with the main memory system, and configured to transmit second capacity information for a second storage region included therein to the main memory system according to a request of the main memory system during the initial operation period, and set a size of logical-to-physical (L2P) mapping of the second storage region to a second size unit in response to a second map setting command transmitted from the main memory system during the initial operation period.

The main memory system may be further configured to compare the first and second capacity information and set the first size unit and the second size unit differently within a range larger than the reference size unit depending on a result of the comparison, during the initial operation period.

The main memory system may set the first and second size units by: generating the first and second map setting commands for setting the first size unit larger than the second size unit and transmitting the generated first and second map setting commands to the first and second memory systems when the first storage region is larger than the second storage region, generating the first and second map setting commands for setting the second size unit larger than the first size unit and transmitting the generated first and second map setting commands to the first and second memory systems when the second storage region is larger than the first storage region, and generating the first and second map setting commands for setting one of the first and second size units larger than the other and transmitting the generated first and second map setting commands to the first and second memory systems when sizes of the first storage region and the second storage region are the same.

The main memory system may be further configured to: analyze an input command transferred from the host during a normal operation period after the initial operation period, select, depending on a result of the analysis, the main memory system, the first sub memory system or the second sub memory system to process the input command, and receive, when the first or second sub memory system is selected to process the input command, a result of processing the input command from the selected sub memory system, and transmit the result of processing the input command to the host.

When the input command is a write command, the main memory system may analyze the input command by checking a pattern of write data corresponding to the write command. When the input command is a write command, the main memory system may select the main memory system, the first sub memory system or the second sub memory system by storing the write data in any of the main storage region, the first storage region and the second storage region. When the input command is a read command, the main memory system may analyze the input command by checking a logical address corresponding to the read command. When the input command is a read command, the main memory system may select the main memory system, the first sub memory system or the second sub memory system by reading read data from any of the main storage region, the first storage region and the second storage region.

The write data smaller than a first reference size may be a random pattern and the write data larger than the first reference size may be a sequential pattern. The sequential pattern write data smaller than a second reference size may be a first sequential pattern, and the sequential pattern write data larger than the second reference size may be a second sequential pattern. The main memory system may store the random pattern write data in the main storage region. When the second size unit is set larger than the first size unit, the main memory system may store the first sequential pattern write data in the first storage region, and may store the second sequential pattern write data in the second storage region. When the first size unit is set larger than the second size unit, the main memory system may store the second sequential pattern write data in the first storage region and may store the first random pattern write data in the second storage region.

The main memory system may be further configured to: set a range of a main logical address corresponding to the main storage region, a range of a first logical address corresponding to the first storage region and a range of a second logical address corresponding to the second storage region differently during the initial operation period, share the first logical address with the first sub memory system, share the second logical address with the second sub memory system, and share, with the host, a range of a summed logical address which is obtained by summing the ranges of the main logical address, the first logical address and the second logical address.

When the second size unit is set larger than the first size unit, the write data may be the first sequential pattern and a first input logical address corresponding to the write command is included in the range of the first logical address, the main memory system may store the write data by transmitting the write command and the first input logical address to the first sub memory system to store the write data in the first storage region. When the second size unit is set larger than the first size unit, the write data may be the second sequential pattern and the first input logical address is included in the range of the second logical address, the main memory system may store the write data by transmitting the write command and the first input logical address to the second sub memory system to store the write data in the second storage region. When the first size unit is set larger than the second size unit, the write data may be the first sequential pattern and the first input logical address is included in the range of the second logical address, the main memory system may store the write data by transmitting the write command and the first input logical address to the second sub memory system to store the write data in the second storage region. When the first size unit is set larger than the second size unit, the write data may be the second sequential pattern and the first input logical address is included in the range of the first logical address, the main memory system may store the write data by transmitting the write command and the first input logical address to the first sub memory system to store the write data in the first storage region.

When the second size unit is set larger than the first size unit, the write data may be the second sequential pattern and the first input logical address is included in the range of the first logical address, the main memory system may store the write data by: managing a first intermediate logical address included in the range of the second logical address, as intermediate mapping information, by mapping the first intermediate logical address to the first input logical address, and transmitting the write command and the first intermediate logical address to the second sub memory system to store the write data in the second storage region. When the second size unit is set larger than the first size unit, the write data may be the first sequential pattern and the first input logical address is included in the range of the second logical address, the main memory system may store the write data by: managing a second intermediate logical address included in the range of the first logical address, as the intermediate mapping information, by mapping the second intermediate logical address to the first input logical address, and transmitting the write command and the second intermediate logical address to the first sub memory system to store the write data in the first storage region. When the first size unit is set larger than the second size unit, the write data may be the first sequential pattern and the first input logical address is included in the range of the first logical address, the main memory system may store the write data by: managing a third intermediate logical address included in the range of the second logical address, as the intermediate mapping information, by mapping the third intermediate logical address to the first input logical address, and transmitting the write command and the third intermediate logical address to the second sub memory system to store the write data in the second storage region. When the first size unit is set larger than the second size unit, the write data may be the second sequential pattern and the first input logical address is included in the range of the second logical address, the main memory system may store the write data by: managing a fourth intermediate logical address included in the range of the first logical address, as the intermediate mapping information, by mapping the fourth intermediate logical address to the first input logical address, and transmitting the write command and the fourth intermediate logical address to the first sub memory system to store the write data in the first storage region.

In the case in which a second input logical address corresponding to the read command is not detected in the intermediate mapping information, the main memory system may read the read data from the main storage region in response to the read command and the second input logical address when the second input logical address is included in the range of the main logical address, may read the read data by transmitting the read command and the second input logical address to the first sub memory system to read the read data from the first storage region when the second input logical address is included in the range of the first logical address, and may read the read data by transmitting the read command and the second input logical address to the second sub memory system to read the read data from the second storage region when the second input logical address is included in the range of the second logical address.

In the case in which a fifth intermediate logical address mapped to the second input logical address is detected by referring to the intermediate mapping information, the main memory system may read the read data by transmitting the read command and the fifth intermediate logical address to the first sub memory system to read the read data from the first storage region when the fifth intermediate logical address is included in the range of the first logical address, and may read the read data by transmitting the read command and the fifth intermediate logical address to the second sub memory system to read the read data from the second storage region when the fifth intermediate logical address is included in the range of the second logical address.

The size of logical-to-physical (L2P) mapping of the main storage region may be a size of an information representing a mapping relationship between a physical address of the main storage region and a logical address. The size of logical-to-physical (L2P) mapping of the first storage region may be a size of an information representing a mapping relationship between a physical address of the first storage region and a logical address. The size of logical-to-physical (L2P) mapping of the second storage region may be a size of an information representing a mapping relationship between a physical address of the second storage region and a logical address.

In an embodiment, a data processing system, may include: a host suitable for providing one of first and second requests together with one of first and second logical addresses, which are respectively within first and second ranges; a first system suitable for accessing, in response to the first request, a first storage in first size units based on a first mapping relationship between the first logical address and a first physical address corresponding to the first size; and a second system suitable for accessing, in response to the second request, a second storage in second size units based on a second mapping relationship between the second logical address and a second physical address corresponding to the second size. The first system may be further suitable for accessing, in response to the first request, the first storage in first size units based on a third mapping relationship between the second logical address and a first intermediate logical address within the first range and a fourth mapping relationship between the first intermediate logical address and the first physical address. The second system may be further suitable for accessing, in response to the second request, the second storage in second size units based on a fifth mapping relationship between the first logical address and a second intermediate logical address within the second range and a sixth mapping relationship between the second intermediate logical address and the second physical address.

In the present technology, when at least two physically separated memory systems are coupled to a host, at least two logical addresses corresponding to the at least two memory systems may be summed into one and thereby be shared with the host, and thus, the host may use the at least two physically separated memory systems logically like one memory system.

In addition, in the present technology, when at least two physically separated memory systems are coupled to a host, the respective roles of the at least two memory systems may be determined depending on a coupling relationship with the host, and the size units and patterns of data to be respectively stored in the at least two memory systems may be determined differently from each other depending on the determined roles. Through this, when the at least two physically separated memory systems are used logically like one memory system, it is possible to more efficiently process data.

### BRIEF DESCRIPTION OF THE DRAWINGS

FIGS. 1A to 1C illustrate a data processing system including a plurality of memory systems in accordance with an embodiment of the present disclosure.

FIG. 2 illustrates a setting operation and a command processing operation of the data processing system in accordance with an embodiment of the present disclosure.

FIG. 3 illustrates an example of the command processing operation of the data processing system in accordance with an embodiment of the present disclosure.

FIG. 4 illustrates another example of the command processing operation of the data processing system in accordance with an embodiment of the present disclosure.

FIG. 5 illustrates an operation of managing at least the plurality of memory systems based on logical addresses in the data processing system in accordance with an embodiment of the present disclosure.

FIGS. 6A and 6B illustrate an example of a command processing operation based on logical addresses in the data processing system in accordance with an embodiment of the present disclosure.

FIG. 7 illustrates another example of the command processing operation based on logical addresses in the data processing system in accordance with an embodiment of the present disclosure.

FIGS. 8A to 8D illustrate a data processing system including a plurality of memory systems in accordance with an embodiment of the present disclosure.

FIGS. 9A and 9B illustrate a setting operation and a command processing operation of the data processing system in accordance with an embodiment of the present disclosure.

FIG. 10 illustrates an example of the command processing operation of the data processing system in accordance with an embodiment of the present disclosure.

FIG. 11 illustrates another example of the command processing operation of the data processing system in accordance with an embodiment of the present disclosure.

FIG. 12 illustrates an operation of managing at least the plurality of memory systems based on logical addresses in the data processing system in accordance with an embodiment of the present disclosure.

FIGS. 13A and 13B illustrate an example of a command processing operation based on logical addresses in the data processing system in accordance with an embodiment of the present disclosure.

FIG. 14 illustrates another example of the command processing operation based on logical addresses in the data processing system in accordance with an embodiment of the present disclosure.

### DETAILED DESCRIPTION

Various examples of the disclosure are described below in more detail with reference to the accompanying drawings. Aspects and features of the present invention, however, may be embodied in different ways to form other embodiments, including variations of any of the disclosed embodiments. Thus, the invention is not limited to the embodiments set forth herein. Rather, the described embodiments are provided so that this disclosure is thorough and complete, and fully conveys the disclosure to those skilled in the art to which the invention pertains. Throughout the disclosure, like reference numerals refer to like parts throughout the various figures and examples of the disclosure. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could be termed a second or third element in another instance without indicating any change in the element itself.

The drawings are not necessarily to scale and, in some instances, proportions may be exaggerated in order to clearly illustrate features of the embodiments. When an element is referred to as being connected or coupled to another element, it should be understood that the former can be directly connected or coupled to the latter, or electrically connected or coupled to the latter via one or more intervening elements therebetween. In addition, it will also be understood that when an element is referred to as being “between” two elements, it may be the only element between the two elements, or one or more intervening elements may also be present.

The terminology used herein is for the purpose of describing particular embodiments only and is not intended to limit the invention. As used herein, singular forms are intended to include the plural forms and vice versa, unless the context clearly indicates otherwise. Similarly, the indefinite articles “a” and “an” mean one or more, unless it is clear from the language or context that only one is intended.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the invention pertains in view of the disclosure. It will be further understood that terms, such as those defined in commonly used dictionaries, should be interpreted as having a meaning that is consistent with their meaning in the context of the disclosure and the relevant art, and not be interpreted in an idealized or overly formal sense unless expressly so defined herein.

In the following description, numerous specific details are set forth in order to provide a thorough understanding of the invention. The invention may be practiced without some or all of these specific details. In other instances, well-known process structures and/or processes have not been described in detail in order not to unnecessarily obscure the invention.

It is also noted, that in some instances, as would be apparent to those skilled in the relevant art, a feature or element described in connection with one embodiment may be used singly or in combination with other features or elements of another embodiment, unless otherwise specifically indicated.

Embodiments of the disclosure are described in detail below with reference to the accompanying drawings, wherein like numbers reference like elements.

### First Embodiment

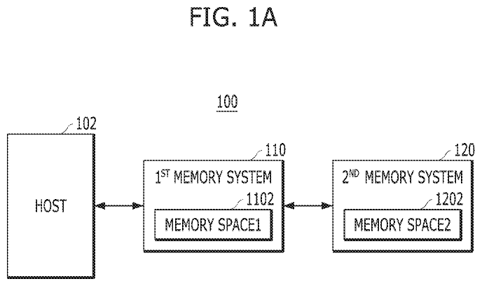

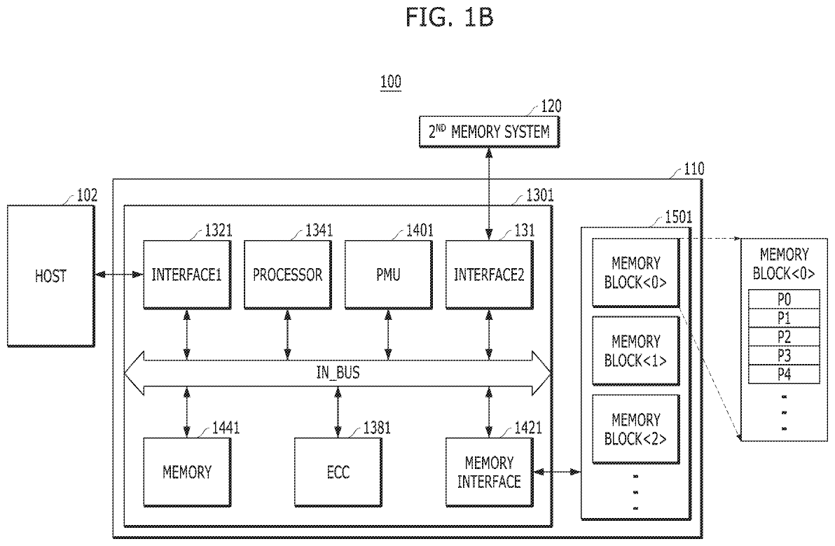

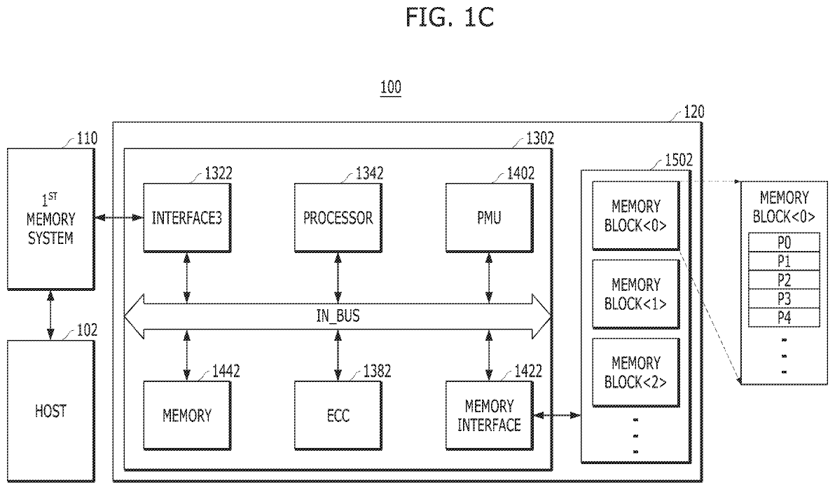

FIGS. 1A to 1C illustrate a data processing system including a plurality of memory systems in accordance with an embodiment of the present disclosure.

Referring to FIG. 1A, a data processing system 100 in accordance with an embodiment of the present disclosure may include a host 102, and a plurality of memory systems 110 and 120.

According to an embodiment, the plurality of memory systems 110 and 120 may include two memory systems, that is, a first memory system 110 and a second memory system 120.

The host 102 may transmit a plurality of commands, corresponding to user requests, to the plurality of memory systems 110 and 120, which may perform a plurality of command operations corresponding to the plurality of commands, that is, operations corresponding to the user requests.

The plurality of memory systems 110 and 120 may operate in response to a request of the host 102, and particularly, may store data to be accessed by the host 102. In other words, either or both of the plurality of memory systems 110 and 120 may be used as a main memory device or an auxiliary memory device of the host 102. Each of the plurality of memory systems 110 and 120 may be implemented as any of various types of storage devices, depending on a host interface protocol which is coupled to the host 102. For example, each of the memory systems 110 and 120 may be realized as a solid state drive (SSD), a multimedia card in the form of an MMC, an eMMC (embedded MMC), an RS-MMC (reduced size MMC) and a micro-MMC, a secure digital card in the form of an SD, a mini-SD and a micro-SD, a universal serial bus (USB) storage device, a universal flash storage (UFS) device, a compact flash (CF) card, a smart media card, and/or a memory stick.

Each of the memory systems 110 and 120 may be integrated into one semiconductor device to configure a memory card, such as a Personal Computer Memory Card International Association (PCMCIA) card, a compact flash (CF) card, a smart media card in the form of an SM and an SMC, a memory stick, a multimedia card in the form of an MMC, an RS-MMC and a micro-MMC, a secure digital card in the form of an SD, a mini-SD, a micro-SD and an SDHC, and/or a universal flash storage (UFS) device.

In another embodiment, each of the memory systems 110 and 120 may configure a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID (radio frequency identification) device, or one of various component elements configuring a computing system.

The first memory system 110 may include a first storage region (MEMORY SPACE1) 1102. The second memory system 120 may include a second storage region (MEMORY SPACE2) 1202. Each of the first storage region 1102 and the second storage region 1202 may include a storage device such as a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable and programmable ROM (EEPROM), a ferroelectric RAM (FRAM), a phase change RAM (PRAM), a magnetic RAM (MRAM), a resistive RAM (RRAM) and a flash memory.

The first memory system 110 may be directly coupled to the host 102. That is to say, the first memory system 110 may receive write data and store the write data in the first storage region 1102, according to a request of the host 102. Also, the first memory system 110 may read data stored in the first storage region 1102 and output the read data to the host 102, according to a request of the host 102.

The second memory system 120 may be directly coupled to the first memory system 110, but may not be directly coupled to the host 102. That is to say, when a command and data are transferred between the second memory system 120 and the host 102, the command and the data may be transferred through the first memory system 110. For example, when receiving write data according to a request of the host 102, the second memory system 120 may receive the write data through the first memory system 110. Of course, the second memory system 120 may store the write data of the host 102, received through the first memory system 110, in the second storage region 1202 included therein. Similarly, when reading read data stored in the second storage region 1202 included therein and outputting the read data to the host 102 according to a request of the host 102, the second memory system 120 may output the read data to the host 102 through the first memory system 110.

Referring to FIG. 1B, detailed configuration of the first memory system 110 is shown.

The first memory system 110 includes a memory device which stores data to be accessed from the host 102, that is, the first nonvolatile memory device 1501, and a first controller 1301 which controls data storage to the first nonvolatile memory device 1501.

The first nonvolatile memory device 1501 may be configured the same as the first storage region 1102 included in the first memory system 110, which is described above with reference to FIG. 1A.

The first controller 1301 controls the first nonvolatile memory device 1501 in response to a request from the host 102. For example, the first controller 1301 provides data read from the first nonvolatile memory device 1501 to the host 102, and stores data provided from the host 102 in the first nonvolatile memory device 1501. To this end, the first controller 1301 controls the operations of the first nonvolatile memory device 1501, such as read, write, program and erase operations.

In detail, the first controller 1301 included in the first memory system 110 may include a first interface (INTERFACE1) 1321, a processor (PROCESSOR) 1341, an error correction code (ECC) component (referred to below simply as ECC) 1381, a power management unit (PMU) 1401, a memory interface (MEMORY INTERFACE) 1421, a memory (MEMORY) 1441, and a second interface (INTERFACE2) 131.

The first interface 1321 performs an operation of exchanging commands and data to be transferred between the first system 110 and the host 102, and may be configured to communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), integrated drive electronics (IDE) and MIPI (mobile industry processor interface). The first interface 1321 may be driven through firmware which is referred to as a host interface layer (HIL), as a region which exchanges data with the host 102.

The ECC 1381 may correct error bit(s) of data processed in the first nonvolatile memory device 1501, and may include an ECC encoder and an ECC decoder. The ECC encoder may perform error correction encoding of data to be programmed to the first nonvolatile memory device 1501, and thereby, may generate data added with parity bits. The data added with parity bits may be stored in the first nonvolatile memory device 1501. The ECC decoder detects and corrects error(s) in data read from the first nonvolatile memory device 1501, when data stored in the first nonvolatile memory device 1501 is read. In other words, after performing error correction decoding of data read from the first nonvolatile memory device 1501, the ECC 1381 may determine whether the error correction decoding has succeeded, may output a signal indicative of that determination, for example, an error correction success/failure signal, and may correct error bit(s) of the read data by using the parity bits generated in the ECC encoding process. If the number of error bits which have occurred is equal to or greater than an error bit correction limit, the ECC 1381 cannot correct the error bits, and may output an error correction failure signal indicating that the error bits cannot be corrected.

The ECC 1381 may perform error correction by using an LDPC (low density parity check) code, a BCH (Bose, Chaudhuri, Hocquenghem) code, a turbo code, a Reed-Solomon code, a convolution code, an RSC (recursive systematic code), or a coded modulation such as a TCM (trellis-coded modulation) or a BCM (block coded modulation). However, error correction is not limited to these techniques. To that end, the ECC 1381 may include suitable hardware and software for error correction.

The PMU 1401 provides and manages the power of the first controller 1301, that is, the power of the components included in the first controller 1301.

The memory interface 1421 serves as a memory/storage interface which performs interfacing between the first controller 1301 and the first nonvolatile memory device 1501, to allow the first controller 1301 to control the first nonvolatile memory device 1501 in response to a request from the host 102. The memory interface 1421 generates control signals for the first nonvolatile memory device 1501 and processes data under the control of the processor 1341, as a NAND flash controller (NFC) when the first nonvolatile memory device 1501 is a flash memory, in particular, a NAND flash memory.

The memory interface 1421 may support the operation of an interface which processes a command and data between the first controller 1301 and the first nonvolatile memory device 1501, for example, a NAND flash interface, in particular, data input/output between the first controller 1301 and the first nonvolatile memory device 1501, and may be driven through firmware which is referred to as a flash interface layer (FIL), as a region which exchanges data with the first nonvolatile memory device 1501.

The second interface 131 may be an interface which processes a command and data between the first controller 1301 and the second memory system 120, that is, a system interface which performs interfacing between the first memory system 110 and the second memory system 120. The second interface 131 may transfer a command and data between the first memory system 110 and the second memory system 120 under the control of the processor 1341.

The memory 1441 as a working memory of the first memory system 110 and the first controller 1301 stores data for driving the first memory system 110 and the first controller 1301. In detail, the memory 1441 temporarily stores data which should be managed, when the first controller 1301 controls the first nonvolatile memory device 1501 in response to a request from the host 102, for example, when the first controller 1301 controls operations of the first nonvolatile memory device 1501, such as read, write, program and erase operations. Further, the memory 1441 may temporarily store data which should be managed, when a command and data are transferred between the first controller 1301 and the second memory system 120.

The memory 1441 may be implemented by a volatile memory. For example, the memory 1441 may be implemented by a static random access memory (SRAM) or a dynamic random access memory (DRAM).

The memory 1441 may be disposed within the first controller 1301 as illustrated in FIG. 1B, or may be disposed externally to the first controller 1301. When the memory 1441 is disposed externally to the first controller 1301, the memory 1441 should be implemented by a separate, external volatile memory operably coupled to exchange data with the first controller 1301 through a separate memory interface (not illustrated).

The memory 1441 may store data which should be managed in a process of controlling the operation of the first nonvolatile memory device 1501 and a process of transferring data between the first memory system 110 and the second memory system 120. To store such data, the memory 1441 may include a program memory, a data memory, a write buffer/cache, a read buffer/cache, a data buffer/cache, a map buffer/cache, and the like.

The processor 1341 controls all operations of the first system 110, and in particular, controls a program operation or a read operation for the first nonvolatile memory device 1501, in response to a write request or a read request from the host 102. The processor 1341 drives firmware which is referred to as a flash translation layer (FTL), to control general operations of the first memory system 110 for the first nonvolatile memory device 1501. The processor 1341 may be realized by a microprocessor or a central processing unit (CPU).

For instance, the first controller 1301 performs an operation requested from the host 102, in the first nonvolatile memory device 1501, that is, performs a command operation corresponding to a command received from the host 102, with the first nonvolatile memory device 1501, through the processor 1341. The first controller 1301 may perform a foreground operation as a command operation corresponding to a command received from the host 102, for example, a program operation corresponding to a write command, a read operation corresponding to a read command, an erase operation corresponding to an erase command or a parameter set operation corresponding to a set parameter command or a set feature command as a set command.

The first controller 1301 may perform a background operation for the first nonvolatile memory device 1501, through the processor 1341. The background operation for the first nonvolatile memory device 1501 may include an operation of copying data stored in a memory block among memory blocks MEMORY BLOCK<0, 1, 2, . . . > of the first nonvolatile memory device 1501, to another memory block, for example, a garbage collection (GC) operation. The background operation for the first nonvolatile memory device 1501 may include an operation of swapping stored data among the memory blocks MEMORY BLOCK<0, 1, 2, . . . > of the first nonvolatile memory device 1501, for example, a wear leveling (WL) operation. The background operation for the first nonvolatile memory device 1501 may include an operation of storing map data stored in the first controller 1301, in the memory blocks MEMORY BLOCK<0, 1, 2, . . . > of the first nonvolatile memory device 1501, for example, a map flush operation. The background operation for the first nonvolatile memory device 1501 may include a bad management operation for the first nonvolatile memory device 1501, for example, a bad block management operation of checking and processing a bad block among the plurality of memory blocks MEMORY BLOCK<0, 1, 2, . . . > included in the first nonvolatile memory device 1501.

The first controller 1301 may generate and manage log data corresponding to an operation of accessing the memory blocks MEMORY BLOCK<0, 1, 2, . . . > of the first nonvolatile memory device 1501, through the processor 1341. The operation of accessing the memory blocks MEMORY BLOCK<0, 1, 2, . . . > of the first nonvolatile memory device 1501 includes performing a foreground operation or a background operation for the memory blocks MEMORY BLOCK<0, 1, 2, . . . > of the first nonvolatile memory device 1501.

In the processor 1341 of the first controller 1301, a unit (not shown) for performing bad management of the first nonvolatile memory device 1501 may be included. The unit for performing bad management of the first nonvolatile memory device 1501 performs a bad block management of checking a bad block among the plurality of memory blocks MEMORY BLOCK<0, 1, 2, . . . > included in the first nonvolatile memory device 1501 and processing the checked bad block as bad. The bad block management means that, when the first nonvolatile memory device 1501 is a flash memory, for example, a NAND flash memory, since a program failure may occur when writing data, for example, programming data, due to the characteristic of the NAND flash memory, a memory block where the program failure has occurred is processed as bad and program-failed data is written, that is, programmed, in a new memory block.

The first controller 1301 performs an operation of transmitting a command and data to be inputted/outputted between the first memory system 110 and the second memory system 120, through the processor 1341. The command and the data which may be inputted/outputted between the first memory system 110 and the second memory system 120 may be transmitted from the host 102 to the first memory system 110.

The first nonvolatile memory device 1501 in the first system 110 may retain stored data even though power is not supplied. In particular, the first nonvolatile memory device 1501 in the first system 110 may store write data WDATA provided from the host 102, through a write operation, and may provide read data (not shown) stored therein, to the host 102, through a read operation.

While the first nonvolatile memory device 1501 may be realized by a nonvolatile memory such as a flash memory, for example, a NAND flash memory, it is to be noted that the first nonvolatile memory device 1501 may be realized by any of various memories such as a phase change memory (PCRAM: phase change random access memory), a resistive memory (RRAM (ReRAM): resistive random access memory), a ferroelectric memory (FRAM: ferroelectric random access memory) and/or a spin transfer torque magnetic memory (STT-RAM (STT-MRAM): spin transfer torque magnetic random access memory).

The first nonvolatile memory device 1501 includes the plurality of memory blocks MEMORY BLOCK<0, 1, 2, . . . >. In other words, the first nonvolatile memory device 1501 may store write data WDATA provided from the host 102, in the memory blocks MEMORY BLOCK<0, 1, 2, . . . >, through a write operation, and may provide read data (not shown) stored in the memory blocks MEMORY BLOCK<0, 1, 2, . . . >, to the host 102, through a read operation.

Each of the memory blocks MEMORY BLOCK<0, 1, 2, . . . > included in the first nonvolatile memory device 1501 includes a plurality of pages P<0, 1, 2, 3, 4, . . . >. Also, while not shown in detail in the drawing, a plurality of memory cells are included in each of the pages P<0, 1, 2, 3, 4, . . . >.

Each of the memory blocks MEMORY BLOCK<0, 1, 2, . . . > included in the first nonvolatile memory device 1501 may be a single level cell (SLC) memory block or a multi-level cell (MLC) memory block, depending on the number of bits which may be stored or expressed in one memory cell included therein. An SLC memory block includes a plurality of pages which are realized by memory cells each storing 1-bit data, and has excellent data computation performance and high durability. An MLC memory block includes a plurality of pages which are realized by memory cells each storing multi-bit data (for example, 2 or more bits), and may be more highly integrated than the SLC memory block since it has a larger data storage space than an SLC memory block.

There are different levels of an MLC memory block. Thus, in a more specific sense, an MLC memory block may refer to a memory block that includes a plurality of pages which are realized by memory cells each capable of storing 2-bit data. Higher level MLC blocks are then given different names to more precisely represent their functionality. For example, a triple level cell (TLC) memory block includes a plurality of pages which are realized by memory cells each capable of storing 3-bit data, a quadruple level cell (QLC) memory block includes a plurality of pages which are realized by memory cells each capable of storing 4-bit data or a multiple level cell memory block includes a plurality of pages which are realized by memory cells each capable of storing 5 or more-bit data.

Referring to FIG. 1C, a detailed configuration of the second memory system 120 is shown.

The second memory system 120 includes a memory device which stores data to be accessed from the host 102, that is, a second nonvolatile memory device 1502, and a second controller 1302 which controls storage of data in the second nonvolatile memory device 1502. The second nonvolatile memory device 1502 may be configured as the second storage region 1202 included in the second memory system 120, which is described above with reference to FIG. 1A.

The second controller 1302 may control the second nonvolatile memory device 1502 in response to a request from the host 102, which is transferred through the first memory system 110. For example, the second controller 1302 may provide data, read from the second nonvolatile memory device 1502, to the host 102 through the first memory system 110, and may store data provided from the host 102, transferred through the first memory system 110, in the second nonvolatile memory device 1502. To this end, the second controller 1302 may control operations of the second nonvolatile memory device 1502, such as read, write, program and erase operations.

In detail, the second controller 1302 included in the second memory system 120 may include a third interface (INTERFACE3)1322, a processor (PROCESSOR) 1342, an error correction code (ECC) component (referred to below simply as ECC) 1382, a power management unit (PMU) 1402, a memory interface (MEMORY INTERFACE) 1422, and a memory (MEMORY) 1442.

Observing the detailed configuration of the second controller 1302 illustrated in FIG. 1C, it may be seen that it is almost the same as the detailed configuration of the first controller 1301 illustrated in FIG. 1B. That is to say, the third interface 1322 in the second controller 1302 may be configured the same as the first interface 1321 in the first controller 1301. The processor 1342 in the second controller 1302 may be configured the same as the processor 1341 in the first controller 1301. The ECC 1382 in the second controller 1302 may be configured the same as the ECC 1381 in the first controller 1301. The PMU 1402 in the second controller 1302 may be configured the same as the PMU 1401 in the first controller 1301. The memory interface 1422 in the second controller 1302 may be configured the same as the memory interface 1421 in the first controller 1301. The memory 1442 in the second controller 1302 may be configured the same as the memory 1441 in the first controller 1301.

A difference may be that the first interface 1321 in the first controller 1301 is an interface for a command and data transferred between the host 102 and the first memory system 110 but the third interface 1322 in the second controller 1302 is an interface for a command and data transferred between the first memory system 110 and the second memory system 120. Another difference may be that the second controller 1302 does not include any component corresponding to the second interface 131 in the first controller 1301.

Except for the above-described differences, other operations of the first controller 1301 and the second controller 1302 are the same; thus, detailed description thereof is omitted here.

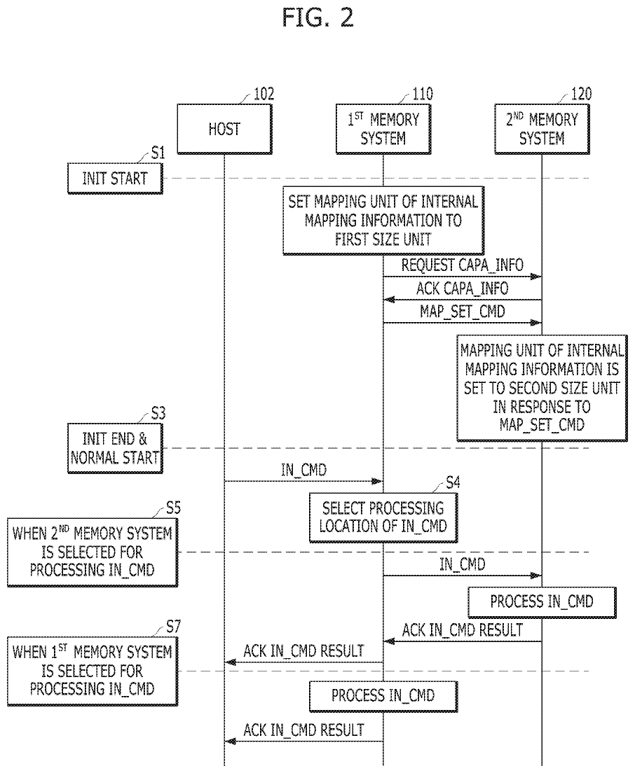

FIG. 2 illustrates a setting operation and a command processing operation of the data processing system 100 in accordance with an embodiment of the present disclosure.

Referring to FIG. 2, operations of the data processing system 100 may include a setting operation in an initial operation period (INIT) and a command processing operation in a normal operation period (NORMAL).

In detail, when the initial operation period (INIT) is started (START) (S1), the first memory system 110 may set a mapping unit of internal mapping information to a first size unit. Namely, a mapping unit of information that indicates a mapping relationship between a physical address of the first storage region 1102 included in the first memory system 110 and a logical address used in the host 102 may be set to the first size unit.

In the state in which the initial operation period (INIT) is started (START), the first memory system 110 may request capacity information (CAPA_INFO) for the second storage region 1202 included in the second memory system 120 (REQUEST CAPA_INFO). The second memory system 120 may transmit the capacity information (CAPA_INFO) for the second storage region 1202 included therein, to the first memory system 110, as a response (ACK) to the request (REQUEST CAPA_INFO) of the first memory system 110 (ACK CAPA_INFO). Thereafter, the second memory system 120 may set a mapping unit of internal mapping information (i.e., a mapping unit of information that indicates a mapping relationship between a physical address of the second storage region 1202 and a logical address) to a second size unit, in response to a map setting command MAP_SET_CMD transmitted from the first memory system 110.

The first memory system 110 may check the capacity information (CAPA_INFO) for the second storage region 1202, received from the second memory system 120 in the state in which the initial operation period (INIT) is started (START), and may set the value of the second size unit which is different from that of the first size unit, depending on a checking result. That is to say, the first memory system 110 may generate the map setting command MAP_SET_CMD for setting a mapping unit of internal mapping information to be managed in the second memory system 120, to the second size unit, depending on a result of checking the capacity information (CAPA_INFO) for the second storage region 1202, received from the second memory system 120, and may transfer the generated map setting command MAP_SET_CMD to the second memory system 120.

The first storage region 1102 in the first memory system 110 and the second storage region 1202 in the second memory system 120 as described above with reference to FIGS. 1A to 1C may be storage spaces including nonvolatile memory cells. The nonvolatile memory cells have a characteristic that overwriting of physical spaces is impossible. Thus, in order to store data, write-requested by the host 102, in the first storage region 1102 and the second storage region 1202 including the nonvolatile memory cells, the first and second memory systems 110 and 120 may perform mapping that couples a file system used by the host 102 and storage spaces including nonvolatile memory cells, through a flash translation layer (FTL). For example, an address of data according to the file system used by the host 102 may be referred to as a logical address or a logical block address, and an address of a storage space for storing data in the first storage region 1102 and the second storage region 1202 including nonvolatile memory cells may be referred to as a physical address or a physical block address. Therefore, the first and second memory systems 110 and 120 may generate and manage mapping information indicating a mapping relationship between a logical address corresponding to a logical sector of the file system used in the host 102 and a physical address corresponding to a physical space of the first storage region 1102 and the second storage region 1202. According to an embodiment, when the host 102 transfers a logical address together with a write command and data to the first memory system 110 or the second memory system 120, the first memory system 110 or the second memory system 120 may search for a storage space for storing the data, in the first storage region 1102 or the second storage region 1202, may map the physical address of the storage space identified in the search to the logical address, and may program the data to the identified storage space. According to an embodiment, when the host 102 transfers a logical address together with a read command to the first memory system 110 or the second memory system 120, the first memory system 110 or the second memory system 120 may search for a physical address mapped to the logical address, may read data stored in the physical address found in the search, from the first storage region 1102 or the second storage region 1202, and may output the read data to the host 102.

In the first storage region 1102 and the second storage region 1202 including nonvolatile memory cells, 512 bytes or any of 1K, 2K and 4K bytes (i.e., a size of a page) may be the size unit. The size unit refers to a unit of a physical space for writing and reading data. The size of a page may be changed depending on a type of a memory device. While it is possible to manage the mapping unit of internal mapping information to correspond to the size of a page, it is also possible to manage the mapping unit of internal mapping information to correspond to a unit larger than the size of a page. For example, while it is possible to manage the 4K byte unit as the mapping unit of internal mapping information, it may also be possible to manage the 512K byte unit or the 1 M byte unit as the mapping unit of internal mapping information. To sum up, the first memory system 110 sets the mapping unit of internal mapping information to the first size unit and the second memory system 120 sets the mapping unit of internal mapping information to the second size unit, which means that the mapping units of the internal mapping information managed in the first memory system 110 and the second memory system 120 may be different from each other.

In further detail, according to an embodiment, as a result of checking the capacity information (CAPA_INFO) for the second storage region 1202, received from the second memory system 120 in the state in which the initial operation period (INIT) is started (START), when the size of the second storage region 1202 is larger than or equal to the size of the first storage region 1102, the first memory system 110 may generate the map setting command MAP_SET_CMD for setting the second size unit as larger than the first size unit, and may transmit the generated map setting command MAP_SET_CMD to the second memory system 120. For example, the first memory system 110 may generate the map setting command MAP_SET_CMD for setting the second size unit to the 512K byte unit larger than the 4K byte unit as the first size unit, and may transmit the generated map setting command MAP_SET_CMD to the second memory system 120.

According to an embodiment, as a result of checking the capacity information (CAPA_INFO) for the second storage region 1202, received from the second memory system 120 in the state in which the initial operation period (INIT) is started (START), when the size of the second storage region 1202 is smaller than the size of the first storage region 1102, the first memory system 110 may generate the map setting command MAP_SET_CMD for setting the second size unit as smaller than the first size unit, and may transmit the generated map setting command MAP_SET_CMD to the second memory system 120. For example, the first memory system 110 may generate the map setting command MAP_SET_CMD for setting the second size unit to the 4K byte unit smaller than a 16K byte unit as the first size unit, and may transmit the generated map setting command MAP_SET_CMD to the second memory system 120.

If the operation of setting the mapping unit of the internal mapping information in the first memory system 110 to the first size unit and setting the mapping unit of the internal mapping information in the second memory system 120 to the second size unit as described above is completed, the initial operation period (INIT) may be ended (END). After the initial operation period (INIT) is ended (END) in this way, the normal operation period (NORMAL) may be started (START) (S3).

For reference, the above-described initial operation period (INIT) may be entered (START)/exited (END) during a process in which the first memory system 110 and the second memory system 120 are booted. Also, the above-described initial operation period (INIT) may be entered (START)/exited (END) at any point of time according to a request of the host 102.

In the state in which the normal operation period (NORMAL) is started (START), the host 102 may generate any command and transmit the generated command to the first memory system 110. That is to say, the first memory system 110 may receive any input command IN_CMD in the state in which the normal operation period (NORMAL) is started (START). The any input command IN_CMD may include all commands which may be generated by the host 102 to control the memory systems 110 and 120, for example, a write command, a read command and an erase command.

In this case, the first memory system 110 may analyze the input command IN_CMD transferred from the host 102, and may select a processing location of the input command IN_CMD depending on an analysis result (S4). In other words, the first memory system 110 may analyze the input command IN_CMD transferred from the host 102 in the state in which the normal operation period (NORMAL) is started (START), and may select, depending on an analysis result, whether to self-process the input command IN_CMD in the first memory system 110 or process the input command IN_CMD in the second memory system 120 (S4).

A result of the operation S4 may indicate that the first memory system 110 self-processes the input command IN_CMD received from the host 102 (S7) or that the first memory system 110 transfers the input command IN_CMD, received from the host 102, to the second memory system 120 and the second memory system 120 processes the input command IN_CMD (S5).

First, an operation may be performed in the following order when the first memory system 110 transfers the input command IN_CMD, transferred from the host 102, to the second memory system 120 and the second memory system 120 processes the input command IN_CMD (S5).

The first memory system 110 may transmit the input command IN_CMD, transferred from the host 102, to the second memory system 120.

The second memory system 120 may perform a command operation in response to the input command IN_CMD transferred through the first memory system 110. For example, when the input command IN_CMD is a write command, the second memory system 120 may store write data, inputted together with the input command IN_CMD, in the second storage region 1202. As another example, when the input command IN_CMD is a read command, the second memory system 120 may read data stored in the second storage region 1202.

The second memory system 120 may transmit a result (RESULT) of processing the input command IN_CMD to the first memory system 110 (ACK IN_CMD RESULT). For example, when the input command IN_CMD is a write command, the second memory system 120 may transmit a response (ACK) notifying that write data inputted together with the input command IN_CMD has been normally stored in the second storage region 1202, to the first memory system 110. As another example, when the input command IN_CMD is a read command, the second memory system 120 may transmit read data, read from the second storage region 1202, to the first memory system 110.

The first memory system 110 may transmit the result (RESULT) of processing the input command IN_CMD, received from the second memory system 120, to the host 102 (ACK IN_CMD RESULT).

Second, an operation may be performed in the following order when the first memory system 110 self-processes the input command IN_CMD transferred from the host 102 (S7).

The first memory system 110 may perform a command operation in response to the input command IN_CMD. For example, when the input command IN_CMD is a write command, the first memory system 110 may store write data, inputted together with the input command IN_CMD, in the first storage region 1102. As another example, when the input command IN_CMD is a read command, the first memory system 110 may read data stored in the first storage region 1102.

The first memory system 110 may transmit a result (RESULT) of processing the input command IN_CMD to the host 102 (ACK IN_CMD RESULT). For example, when the input command IN_CMD is a write command, the first memory system 110 may transmit a response signal notifying that write data inputted together with the input command IN_CMD has been normally stored in the first storage region 1102, to the host 102. As another example, when the input command IN_CMD is a read command, the first memory system 110 may transmit read data, read from the first storage region 1102, to the host 102.

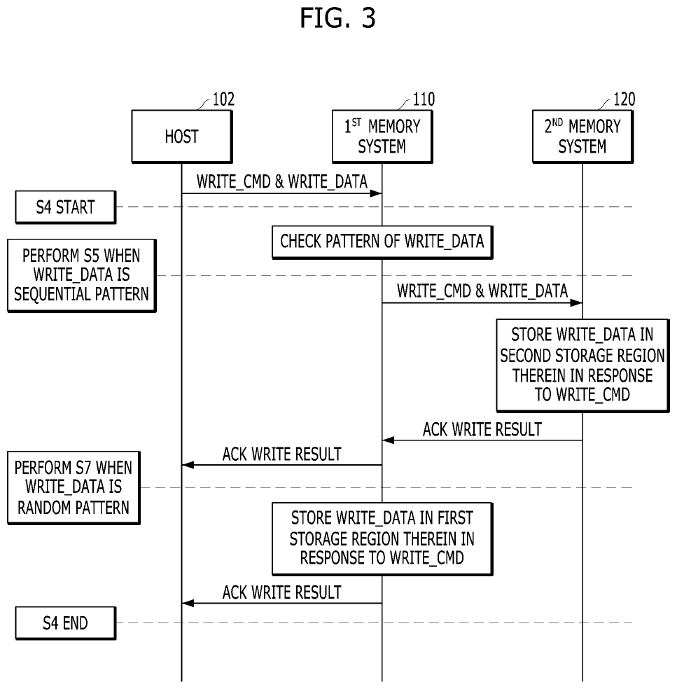

FIG. 3 illustrates an example of the command processing operation of the data processing system 100 in accordance with an embodiment of the present disclosure.

Referring to FIG. 3, a write command processing operation of the command processing operation of the data processing system 100 is described in detail. Namely, the case where the input command IN_CMD is a write command WRITE_CMD in the command processing operation described above with reference to FIG. 2 is described in detail.

In detail, when the input command IN_CMD is the write command WRITE_CMD, write data WRITE_DATA together with the write command WRITE_CMD may be transferred from the host 102 to the first memory system 110.

After, in this way, the write data WRITE_DATA together with the write command WRITE_CMD is transferred from the host 102 to the first memory system 110, the operation S4 may be started. That is to say, after the write data WRITE_DATA together with the write command WRITE_CMD is transferred from the host 102 to the first memory system 110, the first memory system 110 may analyze the write command WRITE_CMD, and may start an operation of selecting a processing location of the write command WRITE_CMD depending on an analysis result (S4 START).

According to an embodiment, the operation of analyzing the write command WRITE_CMD in the first memory system 110 may include an operation of checking a pattern of the write data WRITE_DATA corresponding to the write command WRITE_CMD. For example, the first memory system 110 may compare a size of the write data WRITE_DATA with a reference size, and may identify the pattern of the write data WRITE_DATA smaller than the reference size as a random pattern and identify the pattern of the write data WRITE_DATA larger than the reference size as a sequential pattern.

The operation described with reference to FIG. 3 may be based on the assumption that the second storage region 1202 included in the second memory system 120 is larger than the first storage region 1102 included in the first memory system 110. In other words, the operation described with reference to FIG. 3 may be based on the assumption that a second size unit for mapping a physical address of the second storage region 1202 to a logical address is larger than a first size unit for mapping a physical address of the first storage region 1102 to a logical address. Accordingly, in FIG. 3, in order to store the write data WRITE_DATA, identified as a sequential pattern having a size larger than the reference size, in the second storage region 1202, the first memory system 110 may transfer the write command WRITE_CMD, corresponding to the write data WRITE_DATA identified as the sequential pattern, to the second memory system 120 to allow the second memory system 120 to process the write command WRITE_CMD. Also, in FIG. 3, in order to store the write data WRITE_DATA, identified as a random pattern having a size smaller than the reference size, in the first storage region 1102, the first memory system 110 may self-process the write command WRITE_CMD corresponding to the write data WRITE_DATA identified as the random pattern.

In further detail, as a result of checking the pattern of the write data WRITE_DATA, when the write data WRITE_DATA is a sequential pattern, the first memory system 110 may perform the operation S5, that is, the operation of transferring the write command WRITE_CMD to the second memory system 120 to allow the second memory system 120 to process the write command WRITE_CMD.

In detail, the first memory system 110 may transmit the write command WRITE_CMD and the write data WRITE_DATA, transferred from the host 102, to the second memory system 120 as they are.

The second memory system 120 may store the write data WRITE_DATA in the second storage region 1202 in response to the write command WRITE_CMD transferred through the first memory system 110.

Subsequently, the second memory system 120 may transmit a response (ACK) notifying whether the write data WRITE_DATA has been normally stored in the second storage region 1202, to the first memory system 110 (ACK WRITE RESULT).

The first memory system 110 may transmit a result (RESULT) of processing the write command WRITE_CMD, received from the second memory system 120, to the host 102 (ACK WRITE RESULT).

Further, as a result of checking the pattern of the write data WRITE_DATA, when the write data WRITE_DATA is a random pattern, the first memory system 110 may perform the operation S7, that is, the operation of self-processing the write command WRITE_CMD.

In detail, the first memory system 110 may store the write data WRITE_DATA in the first storage region 1102 in response to the write command WRITE_CMD transferred from the host 102.

Subsequently, the first memory system 110 may transmit a response (ACK) notifying whether the write data WRITE_DATA has been normally stored in the first storage region 1102, to the host 102 (ACK WRITE RESULT).

Depending on a result of checking the pattern of the write data WRITE_DATA corresponding to the write command WRITE_CMD in the first memory system 110 as described above, the first memory system 110 may self-process the write command WRITE_CMD or transfer the write command WRITE_CMD to the second memory system 120 to allow the second memory system 120 to process the write command WRITE_CMD, and then, the operation S4 may be ended (S4 END).

In FIG. 3, it was assumed that the second storage region 1202 included in the second memory system 120 is larger than the first storage region 1102 included in the first memory system 110. When the second storage region 1202 in the second memory system 120 is smaller than the first storage region 1102 in the first memory system 110 (unlike what is shown in FIG. 3), that is, when a second size unit for mapping a physical address of the second storage region 1202 to a logical address is smaller than a first size unit for mapping a physical address of the first storage region 1102 to a logical address, operations may be performed oppositely to the illustration of FIG. 3. Namely, the first memory system 110 may operate in such a manner that, in order to store the write data WRITE_DATA, identified as a sequential pattern having a size larger than the reference size, in the first storage region 1102, the first memory system 110 self-processes the write command WRITE_CMD corresponding to the write data WRITE_DATA identified as the sequential pattern, and in order to store the write data WRITE_DATA, identified as a random pattern having a size smaller than the reference size, in the second storage region 1202, the first memory system 110 transfers the write command WRITE_CMD, corresponding to the write data WRITE_DATA identified as the random pattern, to the second memory system 120 to allow the second memory system 120 to process the write command WRITE_CMD.

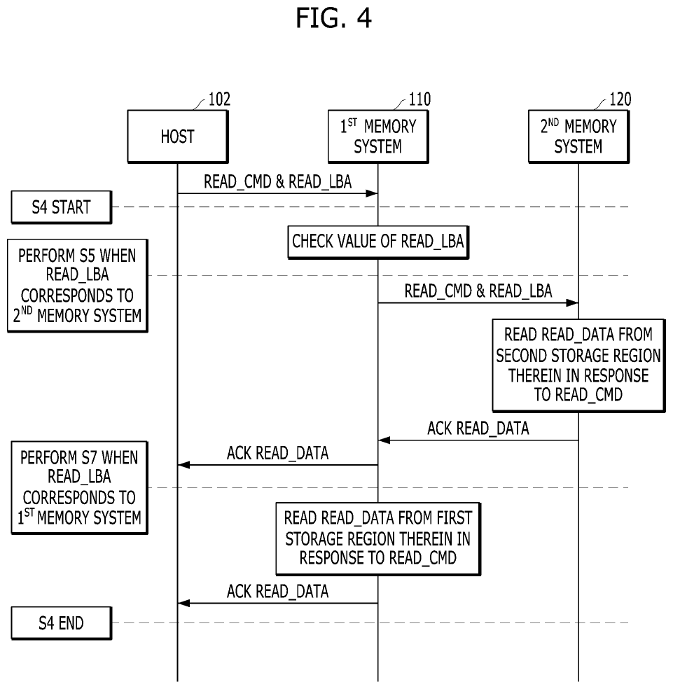

FIG. 4 illustrates another example of the command processing operation of the data processing system 100 in accordance with an embodiment of the present disclosure.

Referring to FIG. 4, a read command processing operation of the command processing operation of the data processing system 100 is described in detail. Namely, the case where the input command IN_CMD is a read command READ_CMD in the command processing operation described above with reference to FIG. 2 is described in detail.

In detail, when the input command IN_CMD is the read command READ_CMD, a logical address READ_LBA together with the read command READ_CMD may be transferred from the host 102 to the first memory system 110.

After, in this way, the logical address READ_LBA together with the read command READ_CMD is transferred from the host 102 to the first memory system 110, the operation S4 may be started. That is to say, after the logical address READ_LBA together with the read command READ_CMD is transferred from the host 102 to the first memory system 110, the first memory system 110 may analyze the read command READ_CMD, and may start an operation of selecting a processing location of the read command READ_CMD depending on an analysis result (S4 START).

According to an embodiment, the operation of analyzing the read command READ_CMD in the first memory system 110 may include an operation of checking a value of the logical address READ_LBA corresponding to the read command READ_CMD. For example, the first memory system 110 may check whether the value of the logical address READ_LBA corresponding to the read command READ_CMD is a logical address managed in internal mapping information included in the first memory system 110 or a logical address managed in internal mapping information included in the second memory system 120.

In further detail, as a result of checking the value of the logical address READ_LBA corresponding to the read command READ_CMD, when the value of the logical address READ_LBA is a logical address managed in the internal mapping information included in the second memory system 120, the first memory system 110 may perform the operation S5, that is, the operation of transferring the read command READ_CMD to the second memory system 120 to allow the second memory system 120 to process the read command READ_CMD.

In detail, the first memory system 110 may transmit the read command READ_CMD and the logical address READ_LBA, transferred from the host 102, to the second memory system 120 as they are.

The second memory system 120 may read data READ_DATA in the second storage region 1202 in response to the read command READ_CMD transferred through the first memory system 110. In other words, the second memory system 120 may search for a physical address (not illustrated) mapped to the logical address READ_LBA corresponding to the read command READ_CMD, and may read the read data READ_DATA in the second storage region 1202 by referring to the physical address found in the search.

Subsequently, the second memory system 120 may transmit the read data READ_DATA, read in the second storage region 1202, to the first memory system 110 (ACK READ_DATA).

The first memory system 110 may transmit the read data READ_DATA, received from the second memory system 120, to the host 102 (ACK READ_DATA).

Further, as a result of checking the value of the logical address READ_LBA corresponding to the read command READ_CMD, when the value of the logical address READ_LBA is a logical address managed in the internal mapping information included in the first memory system 110, the first memory system 110 may perform the operation S7, that is, the operation of self-processing the read command READ_CMD in the first memory system 110.

In detail, the first memory system 110 may read the read data READ_DATA in the first storage region 1102 in response to the read command READ_CMD transferred from the host 102. In other words, the first memory system 110 may search for a physical address (not illustrated) mapped to the logical address READ_LBA corresponding to the read command READ_CMD, and may read the read data READ_DATA in the first storage region 1102 by referring to the physical address found in the search.

The first memory system 110 may transmit the read data READ_DATA, read in the first storage region 1102, to the host 102 (ACK READ_DATA).

Depending on a result of checking the value of the logical address READ_LBA corresponding to the read command READ_CMD in the first memory system 110 as described above, the first memory system 110 may self-process the read command READ_CMD or transfer the read command READ_CMD to the second memory system 120 to allow the second memory system 120 to process the read command READ_CMD, and then, the operation S4 may be ended (S4 END).

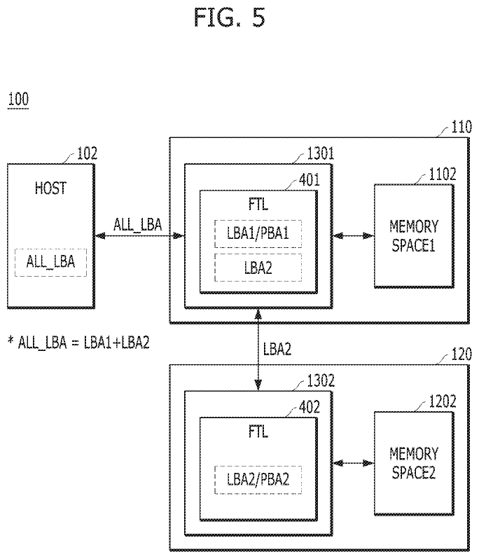

FIG. 5 illustrates an operation of managing at least the plurality of memory systems based on logical addresses in the data processing system 100 in accordance with an embodiment of the present disclosure.

Referring to FIG. 5, the components included in the data processing system 100, that is, the host 102, the first memory system 110 and the second memory system 120, manage logical addresses.

In detail, the first memory system 110 may generate and manage an internal mapping table LBA1/PBA1 in which a first physical address PBA1 corresponding to the first storage region 1102 and a first logical address LBA1 are mapped to each other.

The second memory system 120 may generate and manage an internal mapping table LBA2/PBA2 in which a second physical address PBA2 corresponding to the second storage region 1202 and a second logical address LBA2 are mapped to each other.

The host 102 may use a summed logical address ALL_LBA which is obtained by summing the first logical address LBA1 and the second logical address LBA2.

The size of a storage region which may store data in each of the first memory system 110 and the second memory system 120 may be determined in advance in the process of manufacturing each of the first memory system 110 and the second memory system 120. For example, the size of the first storage region 1102 included in the first memory system 110 is 512 G bytes and the size of the second storage region 1202 included in the second memory system 120 is 1 T bytes may be determined in advance in a process of manufacturing the first memory system 110 and the second memory system 120. In order for the host 102 to normally read/write data from/to the first storage region 1102 and the second storage region 1202 included in the first memory system 110 and the second memory system 120, respectively, the size of each of the first storage region 1102 and the second storage region 1202 should be shared with the host 102. That is to say, the host 102 needs to know how large the size of each of the first storage region 1102 and the second storage region 1202 included in the first memory system 110 and the second memory system 120, respectively, is. When the host 102 knows the size of each of the first storage region 1102 and the second storage region 1202 included in the first memory system 110 and the second memory system 120, the host 102 knows the range of the summed logical address ALL_LBA which is obtained by summing the range of the first logical address LBA1 corresponding to the first storage region 1102 and the range of the second logical address LBA2 corresponding to the second storage region 1202.

As described above with reference to FIG. 2, in the initial operation period (INIT), the first memory system 110 may not only set the mapping unit of the internal mapping information thereof to the first size unit, but also may set the mapping unit of the internal mapping information of the second memory system 120 to the second size unit. Through this, the first memory system 110 may set not only the range of the first logical address LBA1 corresponding to the first storage region 1102 included therein but also the range of the second logical address LBA2 corresponding to the second storage region 1202 included in the second memory system 120. In other words, in the initial operation period (INIT), the first memory system 110 may set the range of the first logical address LBA1 corresponding to the first storage region 1102 and the range of the second logical address LBA2 corresponding to the second storage region 1202, which are different from each other. When the range of the second logical address LBA2 and the range of the first logical address LBA1 are different from each other, the range of the second logical address LBA2 and the range of the first logical address LBA1 do not overlap with each other and are successive. After setting the range of the second logical address LBA2 corresponding to the second storage region 1202 in the initial operation period (INIT), the first memory system 110 may share the range of the second logical address LBA2 with the second memory system 120. Moreover, after setting, in the initial operation period (INIT), the range of the first logical address LBA1 corresponding to the first storage region 1102 and the range of the second logical address LBA2 corresponding to the second storage region 1202, which are different from each other, the first memory system 110 may share the range of the summed logical address ALL_LBA which is obtained by summing the range of the first logical address LBA1 and the range of the second logical address LBA2, with the host 102.

For reference, as illustrated in the drawing, after a flash translation layer (FTL) 401 which may be logically included in the first controller 1301 included in the first memory system 110 sets the range of the first logical address LBA1 and the range of the second logical address LBA2, the first memory system 110 may generate and manage the internal mapping table LBA1/PBA1 in which the first physical address PBA1 corresponding to the first storage region 1102 and the first logical address LBA1 are mapped to each other. Likewise, as illustrated in the drawing, in the second memory system 120, a flash translation layer (FTL) 402 which may be logically included in the second controller 1302 included in the second memory system 120 may generate and manage the internal mapping table LBA2/PBA2 in which the second logical address LBA2 whose range is set by the first memory system 110 and the second physical address PBA2 corresponding to the second storage region 1202 are mapped to each other.

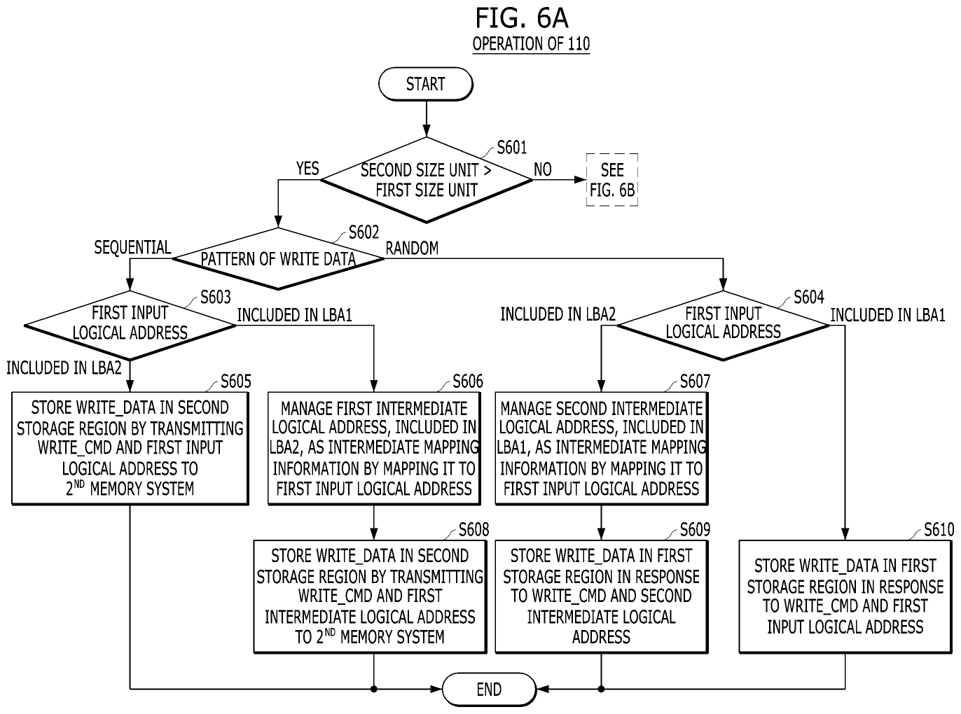

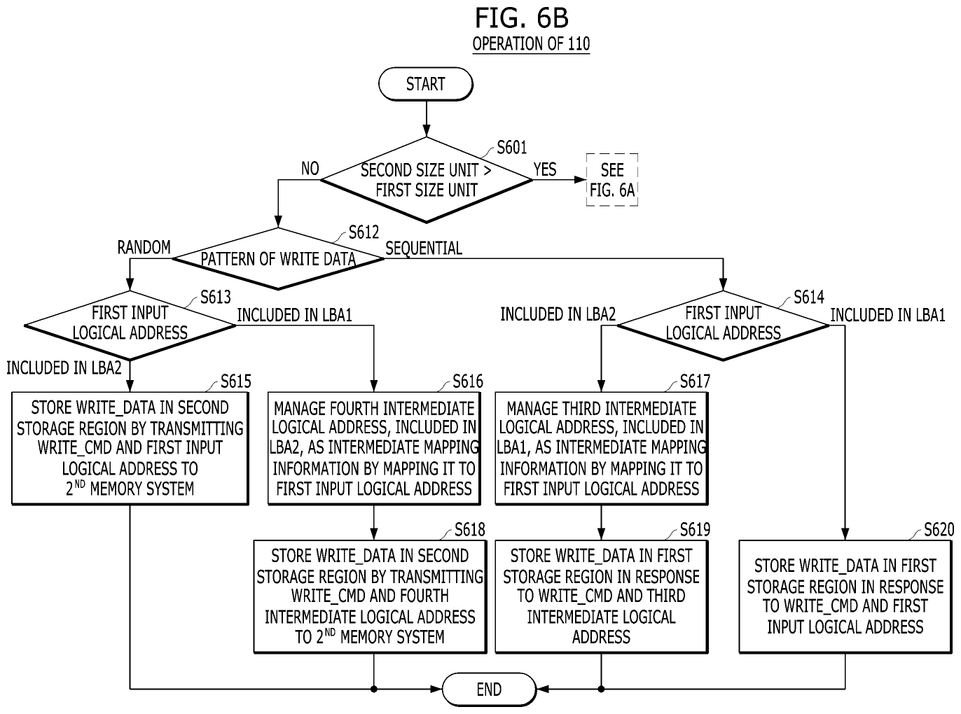

FIGS. 6A and 6B illustrate an example of a command processing operation based on logical addresses in the data processing system 100 in accordance with an embodiment of the present disclosure.

Referring to FIGS. 6A and 6B, a write command processing operation of the command processing operation based on logical addresses in the data processing system 100 is described in detail. Namely, in addition to the operation of processing the write command WRITE_CMD described above with reference to FIGS. 2 and 3, an operation of processing a write command WRITE_CMD based on logical addresses is described in detail.

Referring to FIG. 6A, the second storage region 1202 included in the second memory system 120 is larger than the first storage region 1102 included in the first memory system 110. In other words, the operation to be described with reference to FIG. 6A is described in the context in which a second size unit as the mapping unit of internal mapping information indicating a mapping relationship between a physical address of the second storage region 1202 and a logical address is larger than a first size unit as the mapping unit of internal mapping information indicating a mapping relationship between a physical address of the first storage region 1102 and a logical address (YES of S601). Accordingly, in FIG. 6A, in order to store write data WRITE_DATA, identified as a sequential pattern having a size larger than the reference size, in the second storage region 1202, the first memory system 110 may transfer the write command WRITE_CMD, corresponding to the write data WRITE_DATA identified as the sequential pattern, to the second memory system 120 to allow the second memory system 120 to process the write command WRITE_CMD. Also, in FIG. 6A, in order to store the write data WRITE_DATA, identified as a random pattern having a size smaller than the reference size, in the first storage region 1102, the first memory system 110 may self-process the write command WRITE_CMD corresponding to the write data WRITE_DATA identified as the random pattern.

In detail, in the state in which the second size unit is set larger than the first size unit (YES of S601), the first memory system 110 may check which pattern the write data WRITE_DATA inputted together with the write command WRITE_CMD from the host 102 has (S602).

As a result of the operation of S602, when the write data WRITE_DATA inputted together with the write command WRITE_CMD from the host 102 is a sequential pattern (SEQUENTIAL of S602), the first memory system 110 may check the value of a first input logical address inputted together with the write command WRITE_CMD (S603).

As a result of the operation of S603, when the value of the first input logical address inputted together with the write command WRITE_CMD is included in the range of the second logical address LBA2 managed in the second memory system 120 (INCLUDED IN LBA2 of S603), the first memory system 110 may transmit the write command WRITE_CMD, the first input logical address and the write data WRITE_DATA, inputted from the host 102, to the second memory system 120 such that the write data WRITE_DATA can be stored in the second storage region 1202 included in the second memory system 120 (S605). In response to the write command WRITE_CMD, the second memory system 120 may map a specific physical address, indicating a specific physical region capable of storing data in the second storage region 1202, to the first input logical address, and then, may store the write data WRITE_DATA, transmitted from the first memory system 110, in the specific physical region.

As a result of the operation of S603, when the value of the first input logical address inputted together with the write command WRITE_CMD is included in the range of the first logical address LBA1 managed in the first memory system 110 (INCLUDED IN LBA1 of S603), the first memory system 110 may manage a first intermediate logical address, included in the range of the second logical address LBA2 managed in the second memory system 120, as intermediate mapping information, by mapping the first intermediate logical address to the first input logical address inputted from the host 102 (S606). The first memory system 110 may transmit the first intermediate logical address whose value is determined through the operation S606, to the second memory system 120 together with the write command WRITE_CMD and the write data WRITE_DATA such that the write data WRITE_DATA can be stored in the second storage region 1202 included in the second memory system 120 (S608). In response to the write command WRITE_CMD, the second memory system 120 may map a specific physical address, indicating a specific physical region capable of storing data in the second storage region 1202, to the first intermediate logical address, and then, may store the write data WRITE_DATA, transmitted from the first memory system 110, in the specific physical region.

As a result of the operation of S602, when the write data WRITE_DATA inputted together with the write command WRITE_CMD from the host 102 is a random pattern (RANDOM of S602), the first memory system 110 may check the value of a first input logical address inputted together with the write command WRITE_CMD (S604).

As a result of the operation of S604, when the value of the first input logical address inputted together with the write command WRITE_CMD is included in the range of the second logical address LBA2 managed in the second memory system 120 (INCLUDED IN LBA2 of S604), the first memory system 110 may manage a second intermediate logical address, included in the range of the first logical address LBA1 managed in the first memory system 110, as the intermediate mapping information, by mapping the second intermediate logical address to the first input logical address inputted from the host 102 (S607). The first memory system 110 may store the write data WRITE_DATA in the first storage region 1102 in response to the write command WRITE_CMD and the second intermediate logical address whose value is determined through the operation S607 (S609). In response to the write command WRITE_CMD, the first memory system 110 may map a specific physical address, indicating a specific physical region capable of storing data in the first storage region 1102, to the second intermediate logical address, and then, may store the write data WRITE_DATA, transmitted from the host 102, in the specific physical region.

As a result of the operation of S604, when the value of the first input logical address inputted together with the write command WRITE_CMD is included in the range of the first logical address LBA1 managed in the first memory system 110 (INCLUDED IN LBA1 of S604), the first memory system 110 may store the write data WRITE_DATA in the first storage region 1102 in response to the write command WRITE_CMD and the first input logical address inputted from the host 102 (S610). In response to the write command WRITE_CMD, the first memory system 110 may map a specific physical address, indicating a specific physical region capable of storing data in the first storage region 1102, to the first input logical address, and then, may store the write data WRITE_DATA, transmitted from the host 102, in the specific physical region.

Briefly, even though the first input logical address inputted together with the write command WRITE_CMD is in the range of the second logical address LBA2 managed in the second memory system 120, when the write data WRITE_DATA is stored in the first storage region 1102 depending on the pattern of the write data WRITE_DATA and a comparison of the first size unit and the second size unit, the first memory system 110 may generate and manage the intermediate mapping information to map the first input logical address in the range of the second logical address LBA2 to the second intermediate logical address in the range of the first logical address LBA1 managed in the first memory system 110.

Also, even though the first input logical address inputted together with the write command WRITE_CMD is in the range of the first logical address LBA1 managed in the first memory system 110, when the write data WRITE_DATA is stored in the second storage region 1202 in the second memory system 120 depending on the pattern of the write data WRITE_DATA and a comparison of the first size unit and the second size unit, the first memory system 110 may generate and manage the intermediate mapping information to map the first input logical address in the range of the first logical address LBA1 to the first intermediate logical address in the range of the second logical address LBA2 managed in the second memory system 120.

Referring to FIG. 6B, the second storage region 1202 included in the second memory system 120 is smaller than the first storage region 1102 included in the first memory system 110. In other words, the operation to be described with reference to FIG. 6B is described in the context in which a second size unit as the mapping unit of internal mapping information indicating a mapping relationship between a physical address of the second storage region 1202 and a logical address is smaller than a first size unit as the mapping unit of internal mapping information indicating a mapping relationship between a physical address of the first storage region 1102 and a logical address (NO of S601). Accordingly, in FIG. 6B, in order to store the write data WRITE_DATA, identified as a sequential pattern having a size larger than the reference size, in the first storage region 1102, the first memory system 110 may self-process the write command WRITE_CMD corresponding to the write data WRITE_DATA identified as the sequential pattern. Also, in FIG. 6B, in order to store the write data WRITE_DATA, identified as a random pattern having a size smaller than the reference size, in the second storage region 1202, the first memory system 110 may transfer the write command WRITE_CMD, corresponding to the write data WRITE_DATA identified as the random pattern, to the second memory system 120 to allow the second memory system 120 to process the write command WRITE_CMD.

In detail, in the state in which the second size unit is set smaller than the first size unit (NO of S601), the first memory system 110 may check which pattern the write data WRITE_DATA inputted together with the write command WRITE_CMD from the host 102 has (S612).

As a result of the operation of S612, when the write data WRITE_DATA inputted together with the write command WRITE_CMD from the host 102 is a random pattern (RANDOM of S612), the first memory system 110 may check the value of a first input logical address inputted together with the write command WRITE_CMD (S613).

As a result of the operation of S613, when the value of the first input logical address inputted together with the write command WRITE_CMD is included in the range of the second logical address LBA2 managed in the second memory system 120 (INCLUDED IN LBA2 of S613), the first memory system 110 may transmit the write command WRITE_CMD, the first input logical address and the write data WRITE_DATA, inputted from the host 102, to the second memory system 120 such that the write data WRITE_DATA can be stored in the second storage region 1202 included in the second memory system 120 (S615). In response to the write command WRITE_CMD, the second memory system 120 may map a specific physical address, indicating a specific physical region capable of storing data in the second storage region 1202, to the first input logical address, and then, may store the write data WRITE_DATA, transmitted from the first memory system 110, in the specific physical region.

As a result of the operation of S613, when the value of the first input logical address inputted together with the write command WRITE_CMD is included in the range of the first logical address LBA1 managed in the first memory system 110 (INCLUDED IN LBA1 of S613), the first memory system 110 may manage a fourth intermediate logical address, included in the range of the second logical address LBA2 managed in the second memory system 120, as the intermediate mapping information, by mapping the fourth intermediate logical address to the first input logical address inputted from the host 102 (S616). The first memory system 110 may transmit the fourth intermediate logical address whose value is determined through the operation S616, to the second memory system 120 together with the write command WRITE_CMD and the write data WRITE DATA such that the write data WRITE DATA can be stored in the second storage region 1202 included in the second memory system 120 (S618). In response to the write command WRITE_CMD, the second memory system 120 may map a specific physical address, indicating a specific physical region capable of storing data in the second storage region 1202, to the fourth intermediate logical address, and then, may store the write data WRITE_DATA, transmitted from the first memory system 110, in the specific physical region.

As a result of the operation of S612, when the write data WRITE_DATA inputted together with the write command WRITE_CMD from the host 102 is a sequential pattern (SEQUENTIAL of S612), the first memory system 110 may check the value of a first input logical address inputted together with the write command WRITE_CMD (S614).

As a result of the operation of S614, when the value of the first input logical address inputted together with the write command WRITE_CMD is included in the range of the second logical address LBA2 managed in the second memory system 120 (INCLUDED IN LBA2 of S614), the first memory system 110 may manage a third intermediate logical address, included in the range of the first logical address LBA1 managed in the first memory system 110, as the intermediate mapping information, by mapping the third intermediate logical address to the first input logical address inputted from the host 102 (S617). The first memory system 110 may store the write data WRITE_DATA in the first storage region 1102 in response to the write command WRITE_CMD and the third intermediate logical address whose value is determined through the operation S617 (S619). In response to the write command WRITE_CMD, the first memory system 110 may map a specific physical address, indicating a specific physical region capable of storing data in the first storage region 1102, to the third intermediate logical address, and then, may store the write data WRITE_DATA, transmitted from the host 102, in the specific physical region.

As a result of the operation of S614, when the value of the first input logical address inputted together with the write command WRITE_CMD is included in the range of the first logical address LBA1 managed in the first memory system 110 (INCLUDED IN LBA1 of S614), the first memory system 110 may store the write data WRITE_DATA in the first storage region 1102 in response to the write command WRITE_CMD and the first input logical address inputted from the host 102 (S620). In response to the write command WRITE_CMD, the first memory system 110 may map a specific physical address, indicating a specific physical region capable of storing data in the first storage region 1102, to the first input logical address, and then, may store the write data WRITE_DATA, transmitted from the host 102, in the specific physical region.

Briefly, even though the first input logical address inputted together with the write command WRITE_CMD is in the range of the second logical address LBA2 managed in the second memory system 120, when the write data WRITE_DATA is stored in the first storage region 1102 depending on the pattern of the write data WRITE_DATA and a comparison of the first size unit and the second size unit, the first memory system 110 may generate and manage the intermediate mapping information to map the first input logical address in the range of the second logical address LBA2 to the third intermediate logical address in the range of the first logical address LBA1 managed in the first memory system 110.

Also, even though the first input logical address inputted together with the write command WRITE_CMD is in the range of the first logical address LBA1 managed in the first memory system 110, when the write data WRITE_DATA is stored in the second storage region 1202 in the second memory system 120 depending on the pattern of the write data WRITE_DATA and a comparison of the first size unit and the second size unit, the first memory system 110 may generate and manage the intermediate mapping information to map the first input logical address in the range of the first logical address LBA1 to the fourth intermediate logical address in the range of the second logical address LBA2 managed in the second memory system 120.

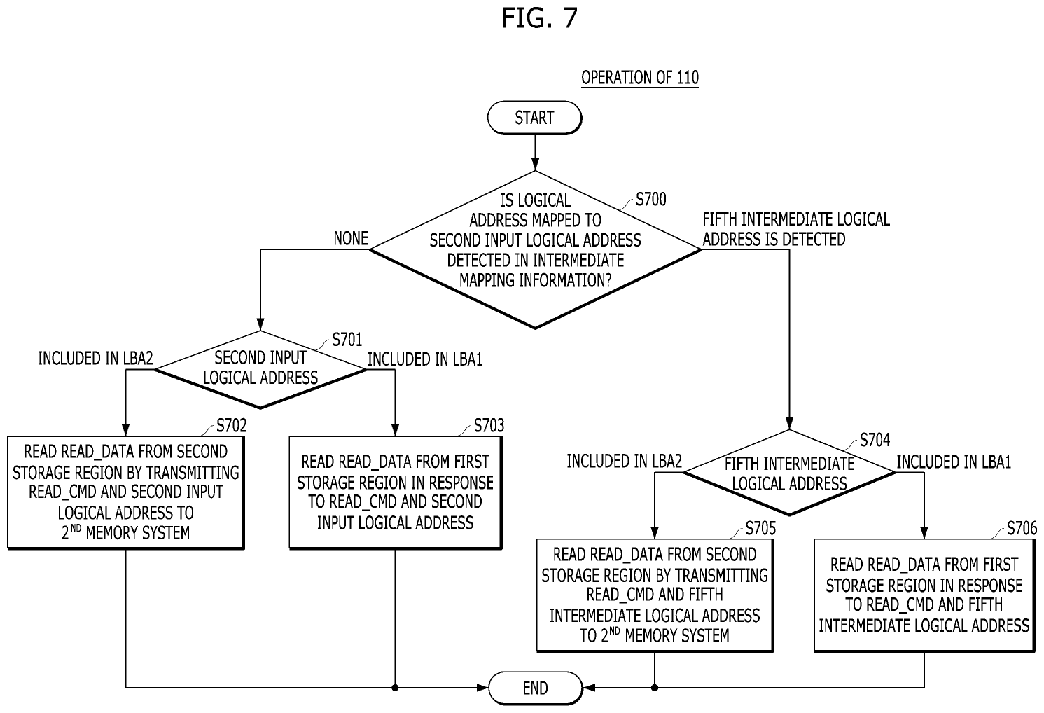

FIG. 7 illustrates another example of the command processing operation based on logical addresses in the data processing system 100 in accordance with an embodiment of the present disclosure.

Referring to FIG. 7, a read command processing operation of the command processing operation based on logical addresses in the data processing system 100 is described in detail. Namely, in addition to the operation of processing the read command READ_CMD described above with reference to FIGS. 2 and 4, an operation of processing a read command READ_CMD based on logical addresses is described in detail.

In detail, the first memory system 110 may check whether a second input logical address inputted together with the read command READ_CMD from the host 102 is detected in intermediate mapping information (S700).

As described above with reference to FIGS. 6A and 6B, even though the first input logical address inputted together with the write command WRITE_CMD is included in the range of the second logical address LBA2 managed in the second memory system 120, when the write data WRITE_DATA is stored in the first storage region 1102 depending on the pattern of the write data WRITE_DATA and a comparison result of the first size unit and the second size unit, the first memory system 110 may generate and manage the intermediate mapping information to map the first input logical address included in the range of the second logical address LBA2 to the intermediate logical address included in the range of the first logical address LBA1 managed in the first memory system 110.

Also, even though the first input logical address inputted together with the write command WRITE_CMD is included in the range of the first logical address LBA1 managed in the first memory system 110, when the write data WRITE_DATA is stored in the second storage region 1202 included in the second memory system 120 depending on the pattern of the write data WRITE_DATA and a comparison result of the first size unit and the second size unit, the first memory system 110 may generate and manage the intermediate mapping information to map the first input logical address included in the range of the first logical address LBA1 to the intermediate logical address included in the range of the second logical address LBA2 managed in the second memory system 120.

When a logical address mapped to the second input logical address inputted together with the read command READ_CMD from the host 102 is not detected in the intermediate mapping information (NONE of S700), a read operation may be performed on the basis of the second input logical address.

On the contrary, when a fifth intermediate logical address mapped to the second input logical address inputted together with the read command READ_CMD from the host 102 is detected in the intermediate mapping information (FIFTH INTERMEDIATE LOGICAL ADDRESS IS DETECTED of S700), a read operation may be performed on a basis of the fifth intermediate logical address detected in the intermediate mapping information.

As a result of the operation of S700, when a logical address mapped to the second input logical address inputted together with the read command READ_CMD from the host 102 is not detected in the intermediate mapping information (NONE of S700), the first memory system 110 may check the value of the second input logical address (S701).

As a result of the operation of S701, when the value of the second input logical address inputted together with the read command READ_CMD is included in the range of the second logical address LBA2 managed in the second memory system 120 (INCLUDED IN LBA2 of S701), the first memory system 110 may transmit the read command READ_CMD and the second input logical address to the second memory system 120 and thereby read read data READ_DATA in the second storage region 1202 (S702). The second memory system 120 may search for a specific physical address mapped to the second input logical address in internal mapping information in response to the read command READ_CMD, and may read the read data READ_DATA in a specific physical region indicated by the specific physical address in the second storage region 1202.

As a result of the operation of S701, when the value of the second input logical address inputted together with the read command READ_CMD is included in the range of the first logical address LBA1 managed in the first memory system 110 (INCLUDED IN LBA1 of S701), the first memory system 110 may read the read data READ_DATA in the first storage region 1102 in response to the read command READ_CMD and the second input logical address (S703). The first memory system 110 may search for a specific physical address mapped to the second input logical address in the internal mapping information in response to the read command READ_CMD, and may read the read data READ_DATA in a specific physical region indicated by the specific physical address in the first storage region 1102.

As a result of the operation of S700, when the fifth intermediate logical address mapped to the second input logical address inputted together with the read command READ_CMD from the host 102 is detected in the intermediate mapping information (FIFTH INTERMEDIATE LOGICAL ADDRESS IS DETECTED of S700), the first memory system 110 may check the value of the fifth intermediate logical address (S704).

As a result of the operation of S704, when the value of the fifth intermediate logical address detected in the intermediate mapping information is included in the range of the second logical address LBA2 managed in the second memory system 120 (INCLUDED IN LBA2 of S704), the first memory system 110 may transmit the read command READ_CMD and the fifth intermediate logical address to the second memory system 120 and thereby read the read data READ_DATA in the second storage region 1202 (S705). The second memory system 120 may search for a specific physical address mapped to the fifth intermediate logical address in the internal mapping information in response to the read command READ_CMD, and may read the read data READ_DATA in a specific physical region indicated by the specific physical address in the second storage region 1202.

As a result of the operation of S704, when the value of the fifth intermediate logical address detected in the intermediate mapping information is included in the range of the first logical address LBA1 managed in the first memory system 110 (INCLUDED IN LBA1 of S704), the first memory system 110 may read the read data READ_DATA in the first storage region 1102 in response to the read command READ_CMD and the fifth intermediate logical address (S706). The first memory system 110 may search for a specific physical address mapped to the fifth intermediate logical address in the internal mapping information in response to the read command READ_CMD, and may read the read data READ_DATA in a specific physical region indicated by the specific physical address in the first storage region 1102.

As is apparent from the above description, according to the first embodiment of the present disclosure, when the first and second memory systems 110 and 120 physically separated from each other are coupled to the host 102, since the summed logical address ALL_LBA which is obtained by summing the first logical address LBA1 corresponding to the first memory system 110 and the second logical address LBA2 corresponding to the second memory system 120 is shared with the host 102, the host 102 may use the physically separate first and second memory systems 110 and 120 logically like one memory system.

In addition, when the physically separate first and second memory systems 110 and 120 are coupled to the host 102, the roles of the respective first and second memory systems 110 and 120 may be determined depending on a coupling relationship with the host 102, and, according to the determined roles, the size units and patterns of the data stored in the respective first and second memory systems 110 and 120 may be determined differently. For example, data of a random pattern having a relatively small size may be stored in the first memory system 110 which is directly coupled to the host 102, and sequential data having a relatively large size may be stored in the second memory system 120 which is coupled to the host 102 through the first memory system 110. As illustrated, through this, not only may the physically separate first and second memory systems 110 and 120 may be used logically like one memory system, but also the data stored in the respective first and second memory systems 110 and 120 may be efficiently processed.

### Second Embodiment

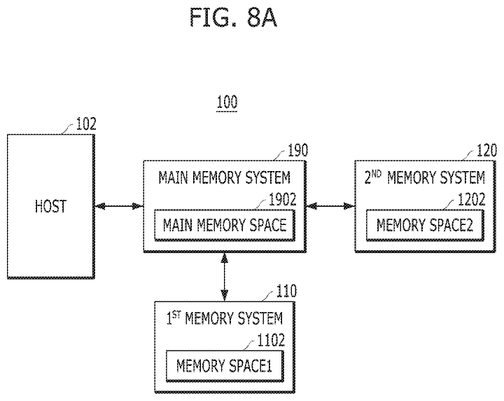

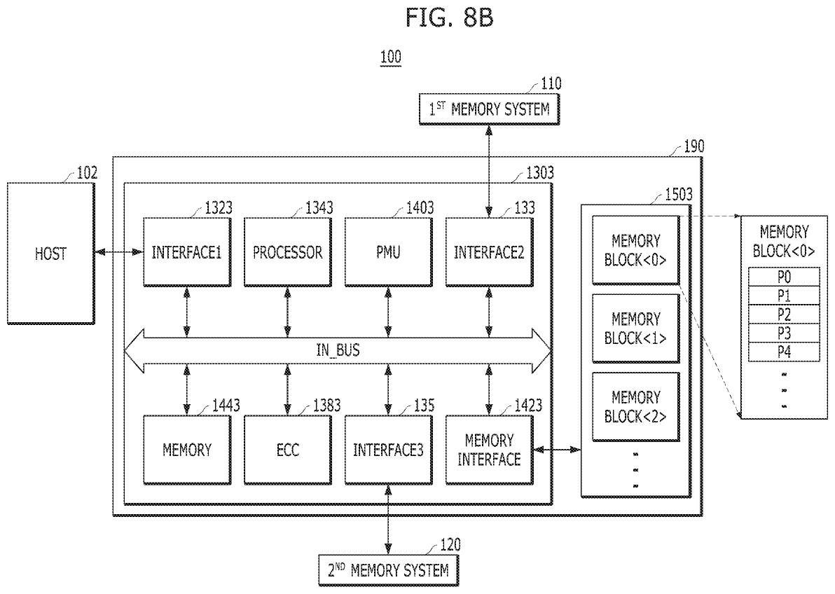

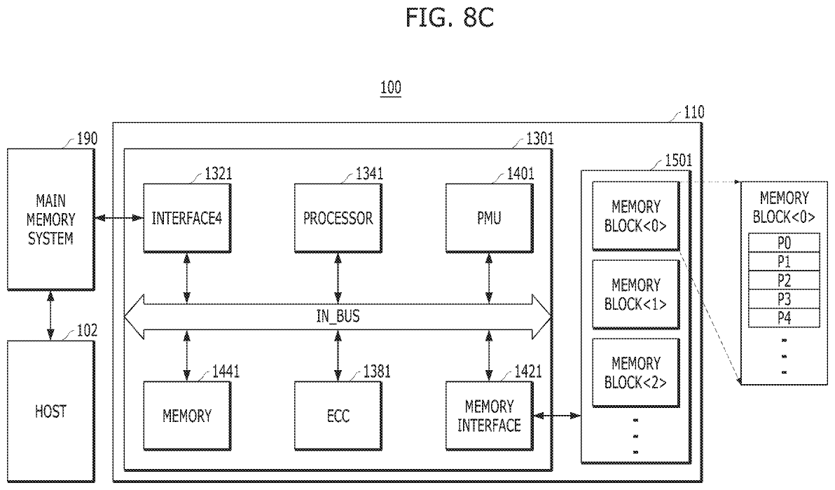

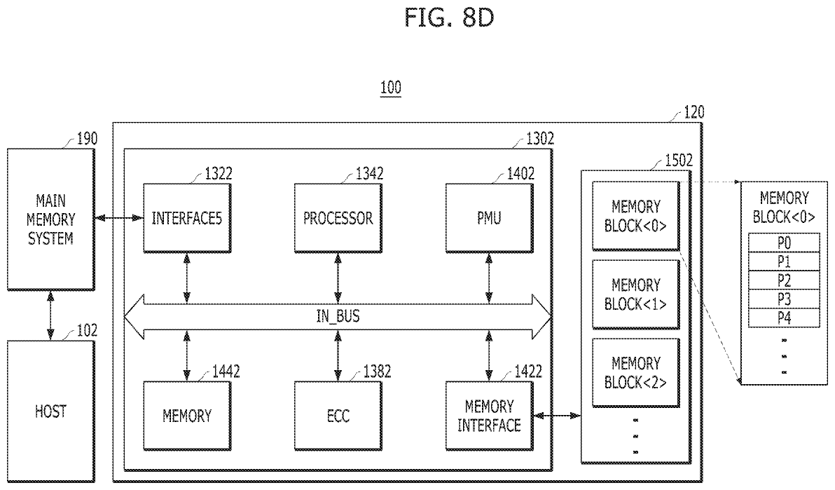

FIGS. 8A to 8D illustrate a data processing system including a plurality of memory systems in accordance with another embodiment of the present disclosure.

Referring to FIG. 8A, a data processing system 100 in accordance with another embodiment of the present disclosure may include a host 102, and a plurality of memory systems 190, 110 and 120.

According to an embodiment, the plurality of memory systems 190, 110 and 120 may include three memory systems, that is, a main memory system 190, a first memory system 110 and a second memory system 120.

The host 102 may transmit a plurality of commands, corresponding to user requests, to the plurality of memory systems 190, 110 and 120, and accordingly, the plurality of memory systems 190, 110 and 120 may perform a plurality of command operations corresponding to the plurality of commands, that is, operations corresponding to the user requests.

The plurality of memory systems 190, 110 and 120 may operate in response to a request of the host 102, and particularly, may store data to be accessed by the host 102. In other words, any of the plurality of memory systems 190, 110 and 120 may be used as a main memory device or an auxiliary memory device of the host 102. Each of the plurality of memory systems 190, 110 and 120 may be implemented as any of various types of storage devices, depending on a host interface protocol which is coupled to the host 102. For example, each of the memory systems 190, 110 and 120 may be realized by a solid state drive (SSD), a multimedia card in the form of an MMC, an eMMC (embedded MMC), an RS-MMC (reduced size MMC) and a micro-MMC, a secure digital card in the form of an SD, a mini-SD and a micro-SD, a universal serial bus (USB) storage device, a universal flash storage (UFS) device, a compact flash (CF) card, a smart media card, and/or a memory stick.

Each of the memory systems 190, 110 and 120 may be integrated into one semiconductor device to configure a memory card, such as a Personal Computer Memory Card International Association (PCMCIA) card, a compact flash (CF) card, a smart media card in the form of an SM and an SMC, a memory stick, a multimedia card in the form of an MMC, an RS-MMC and a micro-MMC, a secure digital card in the form of an SD, a mini-SD, a micro-SD and an SDHC, and/or a universal flash storage (UFS) device.

For another instance, each of the memory systems 190, 110 and 120 may configure a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID (radio frequency identification) device, or one of various component elements configuring a computing system.

The main memory system 190 may include a main storage region (MAIN MEMORY SPACE) 1902. The first memory system 110 may include a first storage region (MEMORY SPACE1) 1102. The second memory system 120 may include a second storage region (MEMORY SPACE2) 1202. Each of the main storage region 1902 included in the main memory system 190 and the first storage region 1102 included in the first memory system 110 and the second storage region 1202 included in the second memory system 120 may include a storage device such as a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable and programmable ROM (EEPROM), a ferroelectric RAM (FRAM), a phase change RAM (PRAM), a magnetic RAM (MRAM), a resistive RAM (RRAM) and a flash memory.

The main memory system 190 may be directly coupled to the host 102. That is to say, the main memory system 190 may receive write data and store the write data in the main storage region 1902, according to a request of the host 102. Also, the main memory system 190 may read data stored in the main storage region 1902 and output the read data to the host 102, according to a request of the host 102.

The first memory system 110 may be directly coupled to the main memory system 190, but may not be directly coupled to the host 102. That is to say, when a command and data are transferred between the first memory system 110 and the host 102, the command and the data may be transferred through the main memory system 190. For example, when receiving write data according to a request of the host 102, the first memory system 110 may receive the write data through the main memory system 190. Of course, the first memory system 110 may store the write data of the host 102, received through the main memory system 190, in the first storage region 1102 included therein. Similarly, when reading read data stored in the first storage region 1102 included therein and outputting the read data to the host 102 according to a request of the host 102, the first memory system 110 may output the read data to the host 102 through the main memory system 190.

The second memory system 120 may be directly coupled to the main memory system 190, but may not be directly coupled to the host 102. That is to say, when a command and data are transferred between the second memory system 120 and the host 102, the command and the data may be transferred through the main memory system 190. For example, when receiving write data according to a request of the host 102, the second memory system 120 may receive the write data through the main memory system 190. Of course, the second memory system 120 may store the write data of the host 102, received through the main memory system 190, in the second storage region 1202 included therein. Similarly, when reading read data stored in the second storage region 1202 included therein and outputting the read data to the host 102 according to a request of the host 102, the second memory system 120 may output the read data to the host 102 through the main memory system 190.

Referring to FIG. 8B, a detailed configuration of the main memory system 190 is shown.

The main memory system 190 includes a memory device which stores data to be accessed from the host 102, that is, a main nonvolatile memory device 1503, and a main controller 1303 which controls storage of data in the main nonvolatile memory device 1503. The main nonvolatile memory device 1503 may be configured as a main storage region 1902 included in the main memory system 190, which is described above with reference to FIG. 8A.

The main controller 1303 controls the main nonvolatile memory device 1503 in response to a request from the host 102. For example, the main controller 1303 provides data read from the main nonvolatile memory device 1503 to the host 102, and stores data provided from the host 102 in the main nonvolatile memory device 1503. To this end, the main controller 1303 controls the operations of the main nonvolatile memory device 1503, such as read, write, program and erase operations.

In detail, the main controller 1303 included in the main memory system 190 may include a first interface (INTERFACE1) 1323, a processor (PROCESSOR) 1343, an error correction code (ECC) component (referred to below simply as ECC) 1383, a power management unit (PMU) 1403, a memory interface (MEMORY INTERFACE) 1423, a memory (MEMORY) 1443, a second interface (INTERFACE2) 133, and a third interface (INTERFACE3) 135.

The first interface 1323 performs an operation of exchanging commands and data to be transferred between the main memory system 190 and the host 102, and may be configured to communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), integrated drive electronics (IDE) and/or MIPI (mobile industry processor interface). The first interface 1323 may be driven through firmware which is referred to as a host interface layer (HIL), as a region which exchanges data with the host 102.

The ECC 1383 may correct an error bit of data processed in the main nonvolatile memory device 1503, and may include an ECC encoder and an ECC decoder. The ECC encoder may perform error correction encoding of data to be programmed to the main nonvolatile memory device 1503, and thereby, may generate data added with parity bits. The data added with parity bits may be stored in the main nonvolatile memory device 1503. The ECC decoder detects and corrects an error included in data read from the main nonvolatile memory device 1503, when data stored in the main nonvolatile memory device 1503 is read. In other words, after performing error correction decoding of data read from the main nonvolatile memory device 1503, the ECC 1383 may determine whether the error correction decoding has succeeded, may output an indication signal, for example, an error correction success/failure signal, depending on a determination result, and may correct an error bit of the read data by using the parity bits generated in the ECC encoding process. If the number of error bits which have occurred is equal to or greater than an error bit correction limit, the ECC 1383 cannot correct the error bits, and may output an error correction failure signal indicating that the error bits cannot be corrected.

The ECC 1383 may perform error correction by using an LDPC (low density parity check) code, a BCH (Bose, Chaudhuri, Hocquenghem) code, a turbo code, a Reed-Solomon code, a convolution code, an RSC (recursive systematic code), or a coded modulation such as a TCM (trellis-coded modulation) or a BCM (block coded modulation). However, error correction is not limited to these techniques. To that end, ECC 1383 may include suitable hardware and software for error correction.

The PMU 1401 provides and manages the power of the main controller 1303, that is, the power of the components included in the main controller 1303.

The memory interface 1423 serves as a memory/storage interface which performs interfacing between the main controller 1303 and the main nonvolatile memory device 1503, to allow the main controller 1303 to control the main nonvolatile memory device 1503 in response to a request from the host 102. The memory interface 1423 generates control signals for the main nonvolatile memory device 1503 and processes data under the control of the processor 1343, as a NAND flash controller (NFC) when the main nonvolatile memory device 1503 is a flash memory, in particular, when the main nonvolatile memory device 1503 is a NAND flash memory.

The memory interface 1423 may process a command and data between the main controller 1303 and the main nonvolatile memory device 1503, and may support, for example, the operation of a NAND flash interface, in particular, input/output of data between the main controller 1303 and the main nonvolatile memory device 1503. The memory interface 1423 as a region which exchanges data with the main nonvolatile memory device 1503 may be driven through firmware which is referred to as a flash interface layer (FIL).

The second interface 133 may be an interface which processes a command and data between the main controller 1303 and the first memory system 110, that is, a system interface which performs interfacing between the main memory system 190 and the first memory system 110. The second interface 133 may transfer a command and data between the main memory system 190 and the first memory system 110 under the control of the processor 1343.

The third interface 135 may be an interface which processes a command and data between the main controller 1303 and the second memory system 120, that is, a system interface which performs interfacing between the main memory system 190 and the second memory system 120. The third interface 135 may transfer a command and data between the main memory system 190 and the second memory system 120 under the control of the processor 1343.

The memory 1443 as a working memory of the main memory system 190 and the main controller 1303 stores data for the driving of the main memory system 190 and the main controller 1303. In detail, the memory 1443 temporarily stores data which should be managed, when the main controller 1303 controls the main nonvolatile memory device 1503 in response to a request from the host 102, for example, when the main controller 1303 controls operations of the main nonvolatile memory device 1503, such as read, write, program and erase operations. Further, the memory 1443 may temporarily store data which should be managed, when a command and data are transferred between the main controller 1303 and the first memory system 110. Further, the memory 1443 may temporarily store data which should be managed, when a command and data are transferred between the main controller 1303 and the second memory system 120.

The memory 1443 may be implemented by a volatile memory. For example, the memory 1443 may be implemented by a static random access memory (SRAM) or a dynamic random access memory (DRAM).

The memory 1443 may be disposed within the main controller 1303 as illustrated in FIG. 8B, or may be disposed externally to the main controller 1303. When the memory 1443 is externally disposed to the main controller 1303, the memory 1443 should be implemented by a separate, external volatile memory operably coupled to exchange data with the main controller 1303 through a separate memory interface (not illustrated).

The memory 1443 may store data which should be managed in a process of controlling the operation of the main nonvolatile memory device 1503 and a process of transferring data between the main memory system 190 and the first memory system 110 and a process of transferring data between the main memory system 190 and the second memory system 120. To store such data, the memory 1443 may include a program memory, a data memory, a write buffer/cache, a read buffer/cache, a data buffer/cache, a map buffer/cache, and the like.

The processor 1343 controls all operations of the main memory system 190, and in particular, controls a program operation or a read operation for the main nonvolatile memory device 1503, in response to a write request or a read request from the host 102. The processor 1343 drives firmware which is referred to as a flash translation layer (FTL), to control general operations of the main memory system 190 for the main nonvolatile memory device 1503. The processor 1343 may be realized by a microprocessor or a central processing unit (CPU).

For instance, the main controller 1303 performs an operation requested from the host 102, in the main nonvolatile memory device 1503, that is, performs a command operation corresponding to a command received from the host 102, with the main nonvolatile memory device 1503, through the processor 1343. The main controller 1303 may perform a foreground operation as a command operation corresponding to a command received from the host 102, for example, a program operation corresponding to a write command, a read operation corresponding to a read command, an erase operation corresponding to an erase command or a parameter set operation corresponding to a set parameter command or a set feature command as a set command.

The main controller 1303 may perform a background operation for the main nonvolatile memory device 1503, through the processor 1343. The background operation for the main nonvolatile memory device 1503 may include an operation of copying data stored in a memory block among memory blocks MEMORY BLOCK<0, 1, 2, . . . > of the main nonvolatile memory device 1503, to another memory block, for example, a garbage collection (GC) operation. The background operation for the main nonvolatile memory device 1503 may include an operation of swapping stored data among the memory blocks MEMORY BLOCK<0, 1, 2, . . . > of the main nonvolatile memory device 1503, for example, a wear leveling (WL) operation. The background operation for the main nonvolatile memory device 1503 may include an operation of storing map data stored in the main controller 1303, in the memory blocks MEMORY BLOCK<0, 1, 2, . . . > of the main nonvolatile memory device 1503, for example, a map flush operation. The background operation for the main nonvolatile memory device 1503 may include a bad management operation for the main nonvolatile memory device 1503, for example, a bad block management operation of checking and processing a bad block among the plurality of memory blocks MEMORY BLOCK<0, 1, 2, . . . > included in the main nonvolatile memory device 1503.

The main controller 1303 may generate and manage log data corresponding to an operation of accessing the memory blocks MEMORY BLOCK<0, 1, 2, . . . > of the main nonvolatile memory device 1503, through the processor 1343. The operation of accessing the memory blocks MEMORY BLOCK<0, 1, 2, . . . > of the main nonvolatile memory device 1503 includes performing a foreground operation or a background operation for the memory blocks MEMORY BLOCK<0, 1, 2, . . . > of the main nonvolatile memory device 1503.

In the processor 1343 of the main controller 1303, a unit (not shown) for performing bad management of the main nonvolatile memory device 1503 may be included. The unit for performing bad management of the main nonvolatile memory device 1503 performs a bad block management of checking a bad block among the plurality of memory blocks MEMORY BLOCK<0, 1, 2, . . . > included in the main nonvolatile memory device 1503 and processing the checked bad block as bad. The bad block management means that, when the main nonvolatile memory device 1503 is a flash memory, for example, a NAND flash memory, since a program failure may occur when writing data, for example, programming data, due to the characteristic of the NAND flash memory, a memory block where the program failure has occurred is processed as bad and program-failed data is written, that is, programmed, in a new memory block.

The main controller 1303 performs an operation of transmitting a command and data to be inputted/outputted between the main memory system 190 and the second memory system 120, through the processor 1343 which is implemented by a microprocessor or a central processing unit (CPU). The command and the data which may be inputted/outputted between the main memory system 190 and the second memory system 120 may be transmitted from the host 102 to the main memory system 190.

The main nonvolatile memory device 1503 in the main memory system 190 may retain stored data even though power is not supplied. In particular, the main nonvolatile memory device 1503 in the main memory system 190 may store write data WDATA provided from the host 102, through a write operation, and may provide read data (not shown) stored therein, to the host 102, through a read operation.

While the main nonvolatile memory device 1503 may be realized by a nonvolatile memory such as a flash memory, for example, a NAND flash memory, it is to be noted that the main nonvolatile memory device 1503 may be realized by any of various memories such as a phase change memory (PCRAM: phase change random access memory), a resistive memory (RRAM (ReRAM): resistive random access memory), a ferroelectric memory (FRAM: ferroelectric random access memory) and/or a spin transfer torque magnetic memory (STT-RAM (STT-MRAM): spin transfer torque magnetic random access memory).

The main nonvolatile memory device 1503 includes the plurality of memory blocks MEMORY BLOCK<0, 1, 2, . . . >. In other words, the main nonvolatile memory device 1503 may store write data WDATA provided from the host 102, in the memory blocks MEMORY BLOCK<0, 1, 2, . . . >, through a write operation, and may provide read data (not shown) stored in the memory blocks MEMORY BLOCK<0, 1, 2, . . . >, to the host 102, through a read operation.

Each of the memory blocks MEMORY BLOCK<0, 1, 2, . . . > included in the main nonvolatile memory device 1503 includes a plurality of pages P<0, 1, 2, 3, 4, . . . >. Also, while not shown in detail in the drawing, a plurality of memory cells are included in each of the pages P<0, 1, 2, 3, 4, . . . >.

Each of the memory blocks MEMORY BLOCK<0, 1, 2, . . . > included in the main nonvolatile memory device 1503 may be a single level cell (SLC) memory block or a multi-level cell (MLC) memory block, depending on the number of bits which may be stored or expressed in one memory cell included therein. An SLC memory block includes a plurality of pages which are realized by memory cells each storing 1-bit data, and has excellent data computation performance and high durability. An MLC memory block includes a plurality of pages which are realized by memory cells each storing multi-bit data (for example, 2 or more bits), and may be more highly integrated than the SLC memory block since it has a larger data storage space than an SLC memory block.

There are different types of MLC memory blocks of different storage capacities as described above.

Referring to FIG. 8C, a detailed configuration of the first memory system 110 is shown.

The first memory system 110 includes a memory device which stores data to be accessed from the host 102, that is, a first nonvolatile memory device 1501, and a first controller 1301 which controls storage of data in the first nonvolatile memory device 1501. The first nonvolatile memory device 1501 may be configured as the first storage region 1102 in the first memory system 110, which is described above with reference to FIG. 8A.

The first controller 1301 may control the first nonvolatile memory device 1501 in response to a request from the host 102, which is transferred through the main memory system 190. For example, the first controller 1301 may provide data, read from the first nonvolatile memory device 1501, to the host 102 through the main memory system 190, and may store data provided from the host 102, transferred through the main memory system 190, in the first nonvolatile memory device 1501. To this end, the first controller 1301 may control operations of the first nonvolatile memory device 1501, such as read, write, program and erase operations.

In detail, the first controller 1301 included in the first memory system 110 may include a fourth interface (INTERFACE4) 1321, a processor (PROCESSOR) 1341, an error correction code (ECC) component (referred to below simply as ECC) 1381, a power management unit (PMU) 1401, a memory interface (MEMORY INTERFACE) 1421, and a memory (MEMORY) 1441.

Observing the detailed configuration of the first controller 1301 illustrated in FIG. 8C, it may be seen that it is almost the same as the detailed configuration of the main controller 1303 illustrated in FIG. 8B. That is to say, the fourth interface 1321 in the first controller 1301 may be configured the same as the first interface 1323 in the main controller 1303. The processor 1341 in the first controller 1301 may be configured the same as the processor 1343 in the main controller 1303. The ECC 1381 in the first controller 1301 may be configured the same as the ECC 1383 in the main controller 1303. The PMU 1401 in the first controller 1301 may be configured the same as the PMU 1403 in the main controller 1303. The memory interface 1421 in the first controller 1301 may be configured the same as the memory interface 1423 in the main controller 1303. The memory 1441 in the first controller 1301 may be configured the same as the memory 1443 in the main controller 1303.

A difference may be that the first interface 1323 in the main controller 1303 is an interface for a command and data transferred between the host 102 and the main memory system 190 but the fourth interface 1321 in the first controller 1301 is an interface for a command and data transferred between the main memory system 190 and the first memory system 110. Another difference may be that the first controller 1301 may not include any components corresponding to the second interface 133 and the third interface 135 in the main controller 1303.

Except for the above-described differences, operations of the main controller 1303 and the first controller 1301 are the same; thus, detailed description thereof is omitted here.

Referring to FIG. 8D, a detailed configuration of the second memory system 120 is shown.

The second memory system 120 includes a memory device which stores data to be accessed from the host 102, that is, a second nonvolatile memory device 1502, and a second controller 1302 which controls storage of data in the second nonvolatile memory device 1502. The second nonvolatile memory device 1502 may be configured as the second storage region 1202 in the second memory system 120, which is described above with reference to FIG. 8A.

The second controller 1302 may control the second nonvolatile memory device 1502 in response to a request from the host 102, which is transferred through the main memory system 190. For example, the second controller 1302 may provide data, read from the second nonvolatile memory device 1502, to the host 102 through the main memory system 190, and may store data provided from the host 102, transferred through the main memory system 190, in the second nonvolatile memory device 1502. To this end, the second controller 1302 may control operations of the second nonvolatile memory device 1502, such as read, write, program and erase operations.

In detail, the second controller 1302 included in the second memory system 120 may include a fifth interface (INTERFACE5) 1322, a processor (PROCESSOR) 1342, an error correction code (ECC) component (referred to below simply as ECC) 1382, a power management unit (PMU) 1402, a memory interface (MEMORY INTERFACE) 1422, and a memory (MEMORY) 1442.

Observing the detailed configuration of the second controller 1302 illustrated in FIG. 8D, it may be seen that it is almost the same as the detailed configuration of the main controller 1303 illustrated in FIG. 8B. That is to say, the fifth interface 1322 in the second controller 1302 may be configured the same as the first interface 1323 in the main controller 1303. The processor 1342 in the second controller 1302 may be configured the same as the processor 1343 in the main controller 1303. The ECC 1382 in the second controller 1302 may be configured the same as the ECC 1383 in the main controller 1303. The PMU 1402 in the second controller 1302 may be configured the same as the PMU 1403 in the main controller 1303. The memory interface 1422 in the second controller 1302 may be configured the same as the memory interface 1423 in the main controller 1303. The memory 1442 in the second controller 1302 may be configured the same as the memory 1443 in the main controller 1303.

A difference may be that the main interface 1323 in the main controller 1303 is an interface for a command and data transferred between the host 102 and the main memory system 190 but the fifth interface 1322 in the second controller 1302 is an interface for a command and data transferred between the main memory system 190 and the second memory system 120. Another difference may be that the second controller 1302 does not include any components corresponding to the second interface 133 and the third interface 135 in the main controller 1303.

Except for the above-described differences, the operations of the main controller 1303 and the second controller 1302 are the same; thus, detailed description thereof is omitted here.

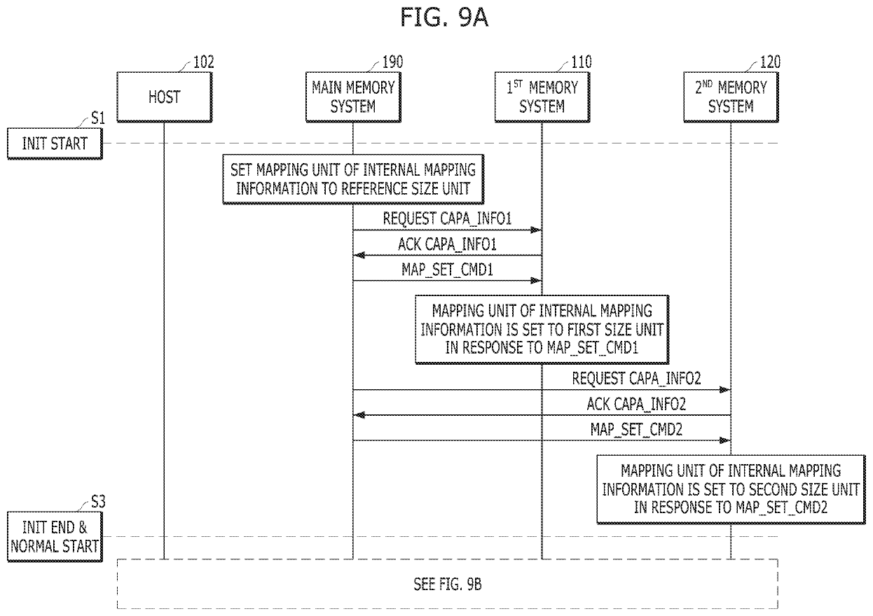

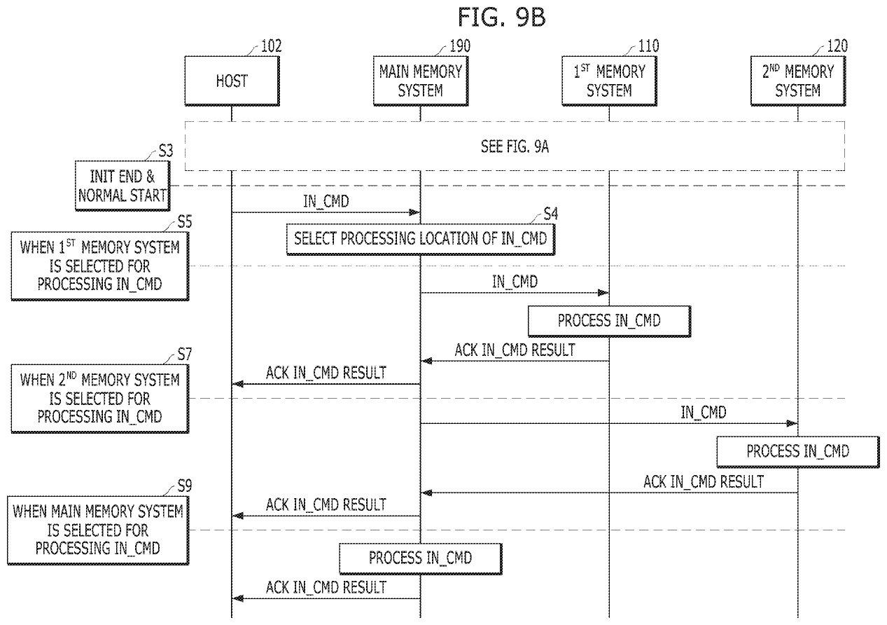

FIGS. 9A and 9B illustrate a setting operation and a command processing operation of the data processing system in accordance with an embodiment of the present disclosure.

Referring to FIGS. 9A and 9B, operations of the data processing system 100 include a setting operation in an initial operation period (INIT) and a command processing operation in a normal operation period (NORMAL).

In detail, referring to FIG. 9A, when the initial operation period (INIT) is started (START) (S1), the main memory system 190 may set a mapping unit of internal mapping information to a reference size unit. Namely, a mapping unit of information that indicates mapping relation between a physical address of the main storage region 1902 included in the main memory system 190 and a logical address used in the host 102 may be set to the reference size unit.

In the state in which the initial operation period (INIT) is started (START), the main memory system 190 may request first capacity information (CAPA_INFO1) for the first storage region 1102 included in the first memory system 110 (REQUEST CAPA_INFO1). The first memory system 110 may transmit the first capacity information (CAPA_INFO1) for the first storage region 1102 included therein, to the main memory system 190, as a response (ACK) to the request (REQUEST CAPA_INFO1) of the main memory system 190 (ACK CAPA_INFO1). Thereafter, the first memory system 110 may set a mapping unit of internal mapping information (i.e., a mapping unit of information that maps a physical address of the first storage region 1102 and a logical address) to a first size unit, in response to a first map setting command MAP_SET_CMD1 transmitted from the main memory system 190.

The main memory system 190 may check the first capacity information (CAPA_INFO1) for the first storage region 1102, received from the first memory system 110 in the state in which the initial operation period (INIT) is started (START), and may set the value of the first size unit which is different from that of the reference size unit, depending on a checking result. That is to say, the main memory system 190 may generate the first map setting command MAP_SET_CMD1 for setting a mapping unit of internal mapping information to be managed in the first memory system 110, to the first size unit, depending on a result of checking the first capacity information (CAPA_INFO1) for the first storage region 1102, received from the first memory system 110, and may transfer the generated first map setting command MAP_SET_CMD1 to the first memory system 110.

In the state in which the initial operation period (INIT) is started (START), the main memory system 190 may request second capacity information (CAPA_INFO2) for the second storage region 1202 included in the second memory system 120 (REQUEST CAPA_INFO2). The second memory system 120 may transmit the second capacity information (CAPA_INFO2) for the second storage region 1202 included therein, to the main memory system 190, as a response (ACK) to the request (REQUEST CAPA_INFO2) of the main memory system 190 (ACK CAPA_INFO2). Thereafter, the second memory system 120 may set a mapping unit of information that maps a physical address of the second storage region 1202 to a logical address, that is, the internal mapping information, to a second size unit, in response to a second map setting command MAP_SET_CMD2 transmitted from the main memory system 190.

The main memory system 190 may check the second capacity information (CAPA_INFO2) for the second storage region 1202, received from the second memory system 120 in the state in which the initial operation period (INIT) is started (START), and may set the value of the second size unit which is different from those of the reference size unit and the first size unit, depending on a checking result. That is to say, the main memory system 190 may generate the second map setting command MAP_SET_CMD2 for setting a mapping unit of internal mapping information to be managed in the second memory system 120, to the second size unit, depending on a result of checking the second capacity information (CAPA_INFO2) for the second storage region 1202, received from the second memory system 120, and may transfer the generated second map setting command MAP_SET_CMD2 to the second memory system 120.

The main storage region 1902 included in the main memory system 190, the first storage region 1102 included in the first memory system 110 and the second storage region 1202 included in the second memory system 120 may be storage spaces including nonvolatile memory cells. The nonvolatile memory cells have a characteristic that overwriting of physical spaces is impossible. Thus, in order to store data, write-requested by the host 102, in the main storage region 1902, the first storage region 1102 and the second storage region 1202 including the nonvolatile memory cells, the main, first and second memory systems 190, 110 and 120 may perform mapping that couples a file system used by the host 102 and storage spaces including nonvolatile memory cells, through a flash translation layer (FTL). For example, an address of data according to the file system used by the host 102 may be referred to as a logical address or a logical block address, and an address of a storage space for storing data in the main storage region 1902, the first storage region 1102 and the second storage region 1202 including nonvolatile memory cells may be referred to as a physical address or a physical block address. Therefore, the main, first and second memory systems 190, 110 and 120 may generate and manage mapping information indicating a mapping relationship between a logical address corresponding to a logical sector of the file system used in the host 102 and a physical address corresponding to a physical space of the main storage region 1902, the first storage region 1102 and the second storage region 1202. According to an embodiment, when the host 102 transfers a logical address together with a write command and data to the main memory system 190, the first memory system 110 or the second memory system 120, the main memory system 190, the first memory system 110 or the second memory system 120 may search for a storage space for storing the data, in main storage region 1902, the first storage region 1102 or the second storage region 1202, may map the physical address of the storage space found in the search to the logical address, and may program the data to that storage space. According to an embodiment, when the host 102 transfers a logical address together with a read command to the main memory system 190, the first memory system 110 or the second memory system 120, the main memory system 190, the first memory system 110 or the second memory system 120 may search for a physical address mapped to the logical address, may read data stored in the physical address found in the search, from the main storage region 1902, the first storage region 1102 or the second storage region 1202, and may output the read data to the host 102.

In the main storage region 1902, the first storage region 1102 and the second storage region 1202 including nonvolatile memory cells, 512 bytes or any of 1K, 2K and 4K bytes (i.e., a size of a page) may be the size unit. The size unit is a unit of a physical space for writing and reading data. The size of a page may be changed depending on a type of a memory device. While it is possible to manage the mapping unit of internal mapping information to correspond to the size of a page, it is also possible to manage the mapping unit of internal mapping information to correspond to a unit larger than the size of a page. For example, while it is possible to manage the 4K byte unit as the mapping unit of internal mapping information, it may also be possible to manage the 512K byte unit or the 1 M byte unit as the mapping unit of internal mapping information. To sum up, when the main memory system 190 sets the mapping unit of internal mapping information to the reference size unit, the first memory system 110 sets the mapping unit of internal mapping information to the first size unit and the second memory system 120 sets the mapping unit of internal mapping information to the second size unit, which means that the mapping units of the internal mapping information managed in the main memory system 190, the first and second memory systems 110 and 120 may be different from one another.

In further detail, according to an embodiment, the main memory system 190 may compare the first capacity information (CAPA_INFO1) for the first storage region 1102, received from the first memory system 110, and the second capacity information (CAPA_INFO2) for the second storage region 1202, received from the second memory system 120, in the state in which the initial operation period (INIT) is started (START).

As a result of the comparison, when the first storage region 1102 is larger than the second storage region 1202, the main memory system 190 may generate the first and second map setting commands MAP_SET_CMD1 and MAP_SET_CMD2 for setting the first size unit as larger than the second size unit, and may transmit the generated first and second map setting commands MAP_SET_CMD1 and MAP_SET_CMD2 to the first and second memory systems 110 and 120. For example, the main memory system 190 may generate the first map setting command MAP_SET_CMD1 for setting the first size unit to 512K bytes and transmit the generated first map setting command MAP_SET_CMD1 to the first memory system 110, and may generate the second map setting command MAP_SET_CMD2 for setting the second size unit to 16K bytes to be smaller than the first size unit and transmit the generated second map setting command MAP_SET_CMD2 to the second memory system 120.

As a result of the comparison, when the first storage region 1102 is smaller than the second storage region 1202, the main memory system 190 may generate the first and second map setting commands MAP_SET_CMD1 and MAP_SET_CMD2 for setting the first size unit as smaller than the second size unit, and may transmit the generated first and second map setting commands MAP_SET_CMD1 and MAP_SET_CMD2 to the first and second memory systems 110 and 120. For example, the main memory system 190 may generate the first map setting command MAP_SET_CMD1 for setting the first size unit to 4K bytes and transmit the generated first map setting command MAP_SET_CMD1 to the first memory system 110, and may generate the second map setting command MAP_SET_CMD2 for setting the second size unit to 256K bytes to be larger than the first size unit and transmit the generated second map setting command MAP_SET_CMD2 to the second memory system 120.

As a result of the comparison, when the sizes of the first storage region 1102 and the second storage region 1202 are the same as each other, the main memory system 190 may generate the first and second map setting commands MAP_SET_CMD1 and MAP_SET_CMD2 for setting any one size unit of the first size unit and the second size unit to be larger and the other size unit of the first size unit and the second size unit to be smaller, and may transmit the generated first and second map setting commands MAP_SET_CMD1 and MAP_SET_CMD2 to the first and second memory systems 110 and 120.

If the operation of setting the mapping unit of the internal mapping information in the main memory system 190 to the reference size unit, setting the mapping unit of the internal mapping information in the first memory system 110 to the first size unit and setting the mapping unit of the internal mapping information in the second memory system 120 to the second size unit as described above is completed, the initial operation period (INIT) may be ended (END). After the initial operation period (INIT) is ended (END) in this way, the normal operation period (NORMAL) may be started (START) (S3).

For reference, the above-described initial operation period (INIT) may be entered (START)/exited (END) during a process in which the main memory system 190, the first memory system 110 and the second memory system 120 are booted. Also, the above-described initial operation period (INIT) may be entered (START)/exited (END) at any point of time according to a request of the host 102.

Referring to FIG. 9B, in the state in which the normal operation period (NORMAL) is started (START), the host 102 may generate any command and transmit the generated command to the main memory system 190. That is to say, the main memory system 190 may receive any input command IN_CMD in the state in which the normal operation period (NORMAL) is started (START). The any input command IN_CMD may include all commands which may be generated by the host 102 to control the memory systems 190, 110 and 120, for example, a write command, a read command and an erase command.

In this case, the main memory system 190 may analyze the input command IN_CMD transferred from the host 102, and may select a processing location of the input command IN_CMD depending on an analysis result (S4). In other words, the main memory system 190 may analyze the input command IN_CMD transferred from the host 102 in the state in which the normal operation period (NORMAL) is started (START), and may select, depending on an analysis result, whether to self-process the input command IN_CMD in the main memory system 190 or process the input command IN_CMD in any one memory system of the first and second memory systems 110 and 120 (S4).

A result of the operation S4 may indicate that the main memory system 190 self-processes the input command IN_CMD received from the host 102 (S9), that the main memory system 190 transfers the input command IN_CMD, received from the host 102, to the first memory system 110 and the first memory system 110 processes the input command IN_CMD (S5), or that the main memory system 190 transfers the input command IN_CMD, received from the host 102, to the second memory system 120 and the second memory system 120 processes the input command IN_CMD (S7).

First, an operation when the main memory system 190 transfers the input command IN_CMD, transferred from the host 102, to the first memory system 110 and the first memory system 110 processes the input command IN_CMD (S5) may be performed in the following order.

The main memory system 190 may transmit the input command IN_CMD, transferred from the host 102, to the first memory system 110.

The first memory system 110 may perform a command operation in response to the input command IN_CMD transferred through the main memory system 190. For example, when the input command IN_CMD is a write command, the first memory system 110 may store write data, inputted together with the input command IN_CMD, in the first storage region 1102. As another example, when the input command IN_CMD is a read command, the first memory system 110 may read data stored in the first storage region 1102.

The first memory system 110 may transmit a result (RESULT) of processing the input command IN_CMD to the main memory system 190 (ACK IN_CMD RESULT). For example, when the input command IN_CMD is a write command, the first memory system 110 may transmit a response (ACK) notifying that write data inputted together with the input command IN_CMD has been normally stored in the first storage region 1102, to the main memory system 190. As another example, when the input command IN_CMD is a read command, the first memory system 110 may transmit read data, read from the first storage region 1102, to the main memory system 190.

The main memory system 190 may transmit the result (RESULT) of processing the input command IN_CMD, received from the first memory system 110, to the host 102 (ACK IN_CMD RESULT).

An operation may be performed in the following order when the main memory system 190 transfers the input command IN_CMD, transferred from the host 102, to the second memory system 120 and the second memory system 120 processes the input command IN_CMD (S7).

The main memory system 190 may transmit the input command IN_CMD, transferred from the host 102, to the second memory system 120.

The second memory system 120 may perform a command operation in response to the input command IN_CMD transferred through the main memory system 190. For example, when the input command IN_CMD is a write command, the second memory system 120 may store write data, inputted together with the input command IN_CMD, in the second storage region 1202. As another example, when the input command IN_CMD is a read command, the second memory system 120 may read data stored in the second storage region 1202.

The second memory system 120 may transmit a result (RESULT) of processing the input command IN_CMD to the main memory system 190 (ACK IN_CMD RESULT). For example, when the input command IN_CMD is a write command, the second memory system 120 may transmit a response (ACK) notifying that write data inputted together with the input command IN_CMD has been normally stored in the second storage region 1202, to the main memory system 190. As another example, when the input command IN_CMD is a read command, the second memory system 120 may transmit read data, read from the second storage region 1202, to the main memory system 190.

The main memory system 190 may transmit the result (RESULT) of processing the input command IN_CMD, received from the second memory system 120, to the host 102 (ACK IN_CMD RESULT).

An operation may be performed in the following order when the main memory system 190 self-processes the input command IN_CMD transferred from the host 102 (S9).

The main memory system 190 may perform a command operation in response to the input command IN_CMD. For example, when the input command IN_CMD is a write command, the main memory system 190 may store write data, inputted together with the input command IN_CMD, in the main storage region 1902. As another example, when the input command IN_CMD is a read command, the main memory system 190 may read data stored in the main storage region 1902.

The main memory system 190 may transmit a result (RESULT) of processing the input command IN_CMD to the host 102 (ACK IN_CMD RESULT). For example, when the input command IN_CMD is a write command, the main memory system 190 may transmit a response signal notifying that write data inputted together with the input command IN_CMD has been normally stored in the main storage region 1902, to the host 102. As another example, when the input command IN_CMD is a read command, the main memory system 190 may transmit read data, read from the main storage region 1902, to the host 102.

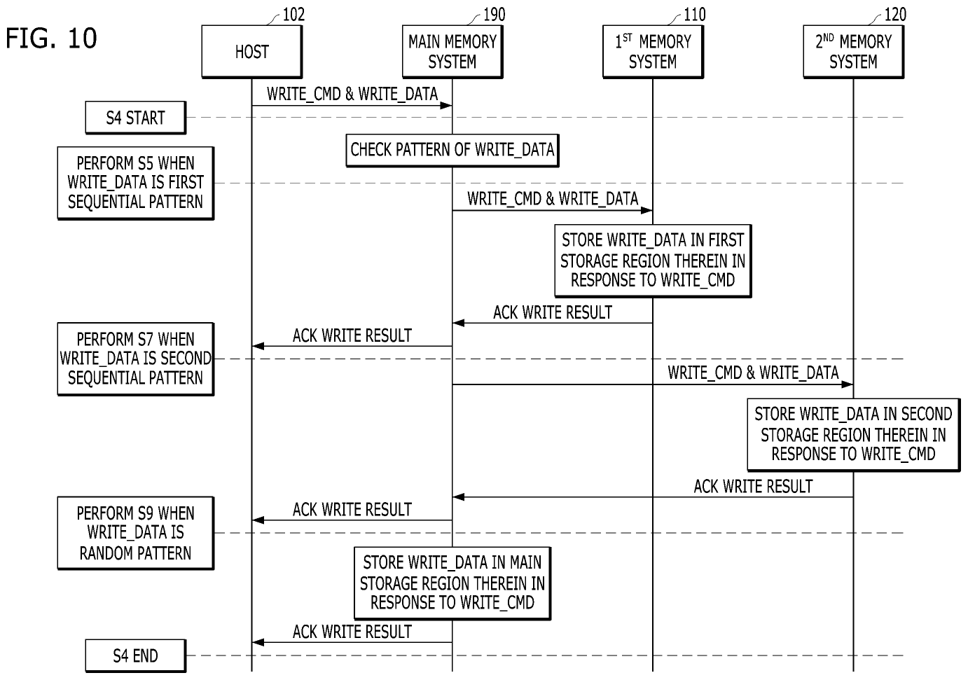

FIG. 10 illustrates an example of the command processing operation of the data processing system 100 in accordance with an embodiment of the present disclosure.

Referring to FIG. 10, a write command processing operation of the command processing operation of the data processing system 100 is described in detail. Namely, the case where the input command IN_CMD is a write command WRITE_CMD in the command processing operation described above with reference to FIG. 9B is described in detail.

In detail, when the input command IN_CMD is the write command WRITE_CMD, write data WRITE_DATA together with the write command WRITE_CMD may be transferred from the host 102 to the main memory system 190.

After, in this way, the write data WRITE_DATA together with the write command WRITE_CMD is transferred from the host 102 to the main memory system 190, the operation S4 may be started. That is to say, after the write data WRITE_DATA together with the write command WRITE_CMD is transferred from the host 102 to the main memory system 190, the main memory system 190 may analyze the write command WRITE_CMD, and may start an operation of selecting a processing location of the write command WRITE_CMD depending on an analysis result (S4 START).

According to an embodiment, the operation of analyzing the write command WRITE_CMD in the main memory system 190 may include an operation of checking a pattern of the write data WRITE_DATA corresponding to the write command WRITE_CMD. For example, the main memory system 190 may compare a size of the write data WRITE_DATA with a first reference size, and may identify the pattern of the write data WRITE_DATA smaller than the first reference size as a random pattern and identify the pattern of the write data WRITE_DATA larger than the first reference size as a sequential pattern. Also, the main memory system 190 may identify write data WRITE_DATA smaller than a second reference size, among the write data WRITE_DATA identified as the sequential pattern, as a first sequential pattern, and may identify write data WRITE_DATA larger than the second reference size as a second sequential pattern. The first reference size may be smaller than the second reference size.

The operation described with reference to FIG. 10 may be based on the assumption that the second storage region 1202 included in the second memory system 120 is larger than the first storage region 1102 included in the first memory system 110. In other words, the operation described with reference to FIG. 10 may be based on the assumption that a second size unit for mapping a physical address of the second storage region 1202 to a logical address is larger than a first size unit for mapping a physical address of the first storage region 1102 to a logical address. Accordingly, in FIG. 10, in order to store write data WRITE_DATA, identified as the second sequential pattern having a size larger than the second reference size, in the second storage region 1202, the main memory system 190 may transfer the write command WRITE_CMD, corresponding to the write data WRITE_DATA identified as the second sequential pattern, to the second memory system 120 to allow the second memory system 120 to process the write command WRITE_CMD. Further, in FIG. 10, in order to store write data WRITE_DATA, identified as the first sequential pattern having a size smaller than the second reference size and larger than the first reference size, in the first storage region 1102, the main memory system 190 may transfer the write command WRITE_CMD, corresponding to the write data WRITE_DATA identified as the first sequential pattern, to the first memory system 110 to allow the first memory system 110 to process the write command WRITE_CMD. Moreover, in FIG. 10, in order to store write data WRITE_DATA, identified as the random pattern having a size smaller than the first reference size, in the main storage region 1902, the main memory system 190 may self-process the write command WRITE_CMD corresponding to the write data WRITE_DATA identified as the random pattern.

In further detail, as a result of checking the pattern of the write data WRITE_DATA, when the write data WRITE_DATA is the first sequential pattern, the main memory system 190 may perform the operation S5, that is, the operation of transferring the write command WRITE_CMD to the first memory system 110 to allow the first memory system 110 to process the write command WRITE_CMD.

In detail, the main memory system 190 may transmit the write command WRITE_CMD and the write data WRITE_DATA, transferred from the host 102, to the first memory system 110 as they are.

The first memory system 110 may store the write data WRITE_DATA in the first storage region 1102 in response to the write command WRITE_CMD transferred through the main memory system 190.

Subsequently, the first memory system 110 may transmit a response (ACK) notifying whether the write data WRITE_DATA has been normally stored in the first storage region 1102, to the main memory system 190 (ACK WRITE RESULT).

The main memory system 190 may transmit the result (RESULT) of processing the write command WRITE_CMD, received from the first memory system 110, to the host 102 (ACK WRITE RESULT).

As a result of checking the pattern of the write data WRITE_DATA, when the write data WRITE_DATA is the second sequential pattern, the main memory system 190 may perform the operation S7, that is, the operation of transferring the write command WRITE_CMD to the second memory system 120 to allow the second memory system 120 to process the write command WRITE_CMD.

In detail, the main memory system 190 may transmit the write command WRITE_CMD and the write data WRITE_DATA, transferred from the host 102, to the second memory system 120 as they are.

The second memory system 120 may store the write data WRITE_DATA in the second storage region 1202 in response to the write command WRITE_CMD transferred through the main memory system 190.

Subsequently, the second memory system 120 may transmit a response (ACK) notifying whether the write data WRITE_DATA has been normally stored in the second storage region 1202, to the main memory system 190 (ACK WRITE RESULT).

The main memory system 190 may transmit the result (RESULT) of processing the write command WRITE_CMD, received from the second memory system 120, to the host 102 (ACK WRITE RESULT).

As a result of checking the pattern of the write data WRITE_DATA, when the write data WRITE_DATA is the random pattern, the main memory system 190 may perform the operation S9, that is, the operation of self-processing the write command WRITE_CMD.

In detail, the main memory system 190 may store the write data WRITE_DATA in the main storage region 1902 in response to the write command WRITE_CMD transferred from the host 102.

Subsequently, the main memory system 190 may transmit a response (ACK) notifying whether the write data WRITE_DATA has been normally stored in the main storage region 1902, to the host 102 (ACK WRITE RESULT).

Depending on a result of checking the pattern of the write data WRITE_DATA corresponding to the write command WRITE_CMD in the main memory system 190 as described above, the main memory system 190 may self-process the write command WRITE_CMD or transfer the write command WRITE_CMD to any one memory system of the first and second memory systems 110 and 120 to allow the any one memory system of the first and second memory systems 110 and 120 to process the write command WRITE_CMD, and then, the operation S4 may be ended (S4 END).

In FIG. 10, it was assumed that the second storage region 1202 included in the second memory system 120 is larger than the first storage region 1102 included in the first memory system 110. When the second storage region 1202 in the second memory system 120 is smaller than the first storage region 1102 in the first memory system 110 (unlike what is shown in FIG. 10), that is, when a second size unit for mapping a physical address of the second storage region 1202 to a logical address is smaller than a first size unit for mapping a physical address of the first storage region 1102 to a logical address, operations may be performed oppositely to the illustration of FIG. 10. Namely, the main memory system 190 may operate in such a manner that, in order to store the write data WRITE_DATA, identified as the second sequential pattern having a size larger than the second reference size, in the first storage region 1102, the main memory system 190 transfers the write command WRITE_CMD, corresponding to the write data WRITE_DATA identified as the second sequential pattern, to the first memory system 110 to allow the first memory system 110 to process the write command WRITE_CMD, and in order to store the write data WRITE_DATA, identified as the first sequential pattern having a size smaller than the second reference size and larger than the first reference size, in the second storage region 1202, the main memory system 190 transfers the write command WRITE_CMD, corresponding to the write data WRITE_DATA identified as the first sequential pattern, to the second memory system 120 to allow the second memory system 120 to process the write command WRITE_CMD.

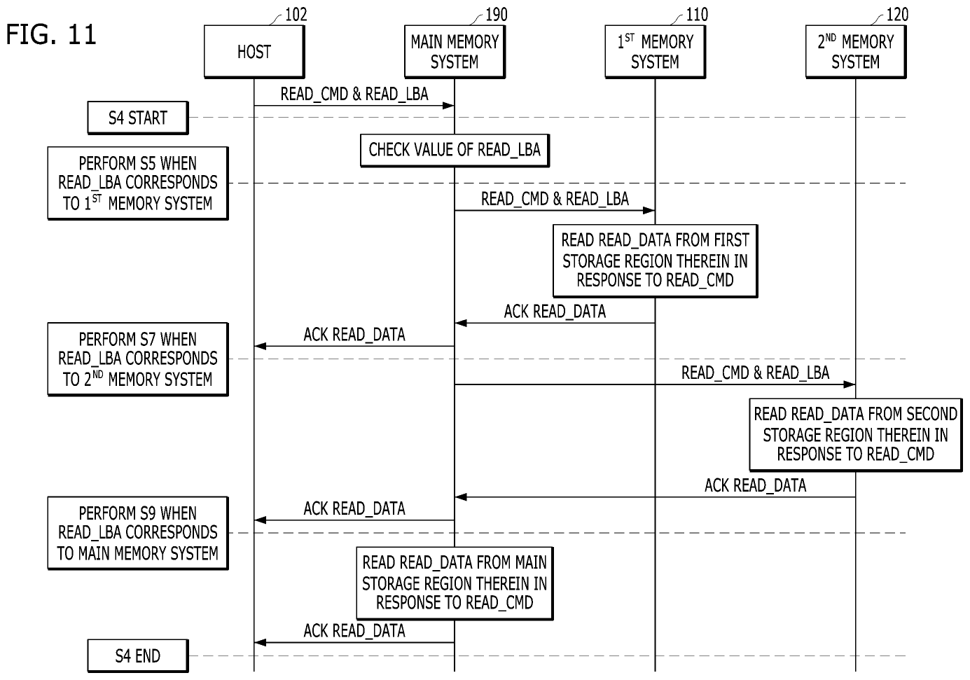

FIG. 11 illustrates another example of the command processing operation of the data processing system 100 in accordance with an embodiment of the present disclosure.

Referring to FIG. 11, a read command processing operation of the command processing operation of the data processing system 100 is described in detail. Namely, the case where the input command IN_CMD is a read command READ_CMD in the command processing operation described above with reference to FIG. 9B is described in detail.

In detail, when the input command IN_CMD is the read command READ_CMD, a logical address READ_LBA together with the read command READ_CMD may be transferred from the host 102 to the main memory system 190.

After, in this way, the logical address READ_LBA together with the read command READ_CMD is transferred from the host 102 to the main memory system 190, the operation S4 may be started. That is to say, after the logical address READ_LBA together with the read command READ_CMD is transferred from the host 102 to the main memory system 190, the main memory system 190 may analyze the read command READ_CMD, and may start an operation of selecting a processing location of the read command READ_CMD depending on an analysis result (S4 START).

According to an embodiment, the operation of analyzing the read command READ_CMD in the main memory system 190 may include an operation of checking a value of the logical address READ_LBA corresponding to the read command READ_CMD. For example, the main memory system 190 may check whether the value of the logical address READ_LBA corresponding to the read command READ_CMD is a logical address managed in internal mapping information included in the main memory system 190, a logical address managed in internal mapping information included in the first memory system 110 or a logical address managed in internal mapping information included in the second memory system 120.

In further detail, as a result of checking the value of the logical address READ_LBA corresponding to the read command READ_CMD, when the value of the logical address READ_LBA is a logical address managed in the internal mapping information included in the first memory system 110, the main memory system 190 may perform the operation S5, that is, the operation of transferring the read command READ_CMD to the first memory system 110 to allow the first memory system 110 to process the read command READ_CMD.

In detail, the main memory system 190 may transmit the read command READ_CMD and the logical address READ_LBA, transferred from the host 102, to the first memory system 110 as they are.

The first memory system 110 may read the read data READ_DATA in the first storage region 1102 in response to the read command READ_CMD transferred through the main memory system 190. In other words, the first memory system 110 may search for a physical address (not illustrated) mapped to the logical address READ_LBA corresponding to the read command READ_CMD, and may read the read data READ_DATA in the first storage region 1102 by referring to the physical address found in the search.

The first memory system 110 may transmit the read data READ_DATA, read in the first storage region 1102, to the main memory system 190 (ACK READ_DATA).

The main memory system 190 may transmit the read data READ_DATA, received from the first memory system 110, to the host 102 (ACK READ_DATA).

As a result of checking the value of the logical address READ_LBA corresponding to the read command READ_CMD, when the value of the logical address READ_LBA is a logical address managed in the internal mapping information included in the second memory system 120, the main memory system 190 may perform the operation S7, that is, the operation of transferring the read command READ_CMD to the second memory system 120 to allow the second memory system 120 to process the read command READ_CMD.

In detail, the main memory system 190 may transmit the read command READ_CMD and the logical address READ_LBA, transferred from the host 102, to the second memory system 120 as they are.

The second memory system 120 may read the read data READ_DATA in the second storage region 1202 in response to the read command READ_CMD transferred through the main memory system 190. In other words, the second memory system 120 may search for a physical address (not illustrated) mapped to the logical address READ_LBA corresponding to the read command READ_CMD, and may read the read data READ_DATA in the second storage region 1202 by referring to the physical address found in the search.

The second memory system 120 may transmit the read data READ_DATA, read in the second storage region 1202, to the main memory system 190 (ACK READ_DATA).

The main memory system 190 may transmit the read data READ_DATA, received from the second memory system 120, to the host 102 (ACK READ_DATA).

Further, as a result of checking the value of the logical address READ_LBA corresponding to the read command READ_CMD, when the value of the logical address READ_LBA is a logical address managed in the internal mapping information included in the main memory system 190, the main memory system 190 may perform the operation S9, that is, the operation of self-processing the read command READ_CMD in the main memory system 190.

In detail, the main memory system 190 may read the read data READ_DATA in the main storage region 1902 in response to the read command READ_CMD transferred from the host 102. In other words, the main memory system 190 may search for a physical address (not illustrated) mapped to the logical address READ_LBA corresponding to the read command READ_CMD, and may read the read data READ_DATA in the main storage region 1902 by referring to the physical address found in the search.

The main memory system 190 may transmit the read data READ_DATA, read in the main storage region 1902, to the host 102 (ACK READ_DATA).

Depending on a result of checking the value of the logical address READ_LBA corresponding to the read command READ_CMD in the main memory system 190 as described above, the main memory system 190 may self-process the read command READ_CMD, transfer the read command READ_CMD to the first memory system 110 to allow the first memory system 110 to process the read command READ_CMD or transfer the read command READ_CMD to the second memory system 120 to allow the second memory system 120 to process the read command READ_CMD, and then, the operation S4 may be ended (S4 END).

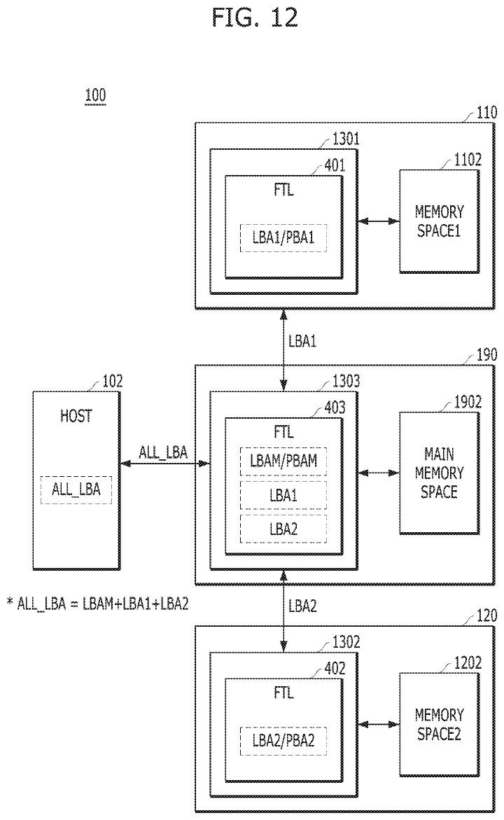

FIG. 12 illustrates an operation of managing at least the plurality of memory systems based on logical addresses in the data processing system 100 in accordance with an embodiment of the present disclosure.

Referring to FIG. 12, the respective components included in the data processing system 100, that is, the host 102, the main memory system 190, the first memory system 110 and the second memory system 120, manage logical addresses.

In detail, the main memory system 190 may generate and manage an internal mapping table LBAM/PBAM in which a main physical address PBAM corresponding to the main storage region 1902 and a main logical address LBAM are mapped to each other.

The first memory system 110 may generate and manage an internal mapping table LBA1/PBA1 in which a first physical address PBA1 corresponding to the first storage region 1102 and a first logical address LBA1 are mapped to each other.

The second memory system 120 may generate and manage an internal mapping table LBA2/PBA2 in which a second physical address PBA2 corresponding to the second storage region 1202 and a second logical address LBA2 are mapped to each other.

The host 102 may use a summed logical address ALL_LBA which is obtained by summing the main logical address LBAM, the first logical address LBA1 and the second logical address LBA2.

The size of a storage region which may store data in each of the main memory system 190, the first memory system 110 and the second memory system 120 may be determined in advance in the process of manufacturing each of the main memory system 190, the first memory system 110 and the second memory system 120. For example, it may be determined in advance, e.g., during fabrication of the memory systems 190, 110, 120, that the size of the main storage region 1902 included in the main memory system 190 is 128 G bytes, the size of the first storage region 1102 included in the first memory system 110 is 512 G bytes and the size of the second storage region 1202 included in the second memory system 120 is 1 T bytes. In order for the host 102 to normally read/write data from/to the main storage region 1902, the first storage region 1102 and the second storage region 1202 included in the main memory system 190, the first memory system 110 and the second memory system 120, respectively, the size of each of the main storage region 1902, the first storage region 1102 and the second storage region 1202 should be shared with the host 102. That is to say, the host 102 needs to know how large the size of each of the main storage region 1902, the first storage region 1102 and the second storage region 1202 included in the main memory system 190, the first memory system 110 and the second memory system 120, respectively, is. When the host 102 knows the size of each of the main storage region 1902, the first storage region 1102 and the second storage region 1202 included in the main memory system 190, the first memory system 110 and the second memory system 120, the host 102 knows the range of the summed logical address ALL_LBA which is obtained by summing the range of the main logical address LBAM corresponding to the main storage region 1902, the range of the first logical address LBA1 corresponding to the first storage region 1102 and the range of the second logical address LBA2 corresponding to the second storage region 1202.

As described above with reference to FIG. 9A, in the initial operation period (INIT), the main memory system 190 may not only set the mapping unit of the internal mapping information thereof to the reference size unit, but also may set the mapping units of the internal mapping information of the first and second memory systems 110 and 120 to the first and second size units, respectively. Through this, the main memory system 190 may set not only the range of the main logical address LBAM corresponding to the main storage region 1902 included therein but also the ranges of the first logical address LBA1 and the second logical address LBA2 corresponding to the first and second storage regions 1102 and 1202 included in the first and second memory systems 110 and 120, respectively. In other words, in the initial operation period (INIT), the main memory system 190 may set the range of the main logical address LBAM corresponding to the main storage region 1902, the range of the first logical address LBA1 corresponding to the first storage region 1102 and the range of the second logical address LBA2 corresponding to the second storage region 1202 differently from one another. When the range of the main logical address LBAM, the range of the first logical address LBA1 and the range of the second logical address LBA2 are different from one another, the range of the main logical address LBAM, the range of the first logical address LBA1 and the range of the second logical address LBA2 do not overlap with each other and are successive. After setting the range of the first logical address LBA1 corresponding to the first storage region 1102 in the initial operation period (INIT), the main memory system 190 may share the range of the first logical address LBA1 with the first memory system 110. After setting the range of the second logical address LBA2 corresponding to the second storage region 1202, the main memory system 190 may share the range of the second logical address LBA2 with the second memory system 120. After setting, in the initial operation period (INIT), the range of the main logical address LBAM corresponding to the main storage region 1902, the range of the first logical address LBA1 corresponding to the first storage region 1102 and the range of the second logical address LBA2 corresponding to the second storage region 1202 differently from one another, the main memory system 190 may share the summed logical address ALL_LBA which is obtained by summing the range of the main logical address LBAM, the range of the first logical address LBA1 and the range of the second logical address LBA2, with the host 102.

For reference, as illustrated in the drawing, after a flash translation layer (FTL) 403 which may be logically included in the main controller 1303 included in the main memory system 190 sets the range of the main logical address LBAM, the range of the first logical address LBA1 and the range of the second logical address LBA2, the main memory system 190 may generate and manage the internal mapping table LBAM/PBAM in which the main physical address PBAM corresponding to the main storage region 1902 and the main logical address LBAM are mapped to each other. Likewise, as illustrated in the drawing, in the first memory system 110, a flash translation layer (FTL) 401 which may be logically included in the first controller 1301 included in the first memory system 110 may generate and manage the internal mapping table LBA1/PBA1 in which the first logical address LBA1 whose range is set by the main memory system 190 and the first physical address PBA1 corresponding to the first storage region 1102 are mapped to each other. Moreover, as illustrated in the drawing, in the second memory system 120, a flash translation layer (FTL) 402 which may be logically included in the second controller 1302 included in the second memory system 120 may generate and manage the internal mapping table LBA2/PBA2 in which the second logical address LBA2 whose range is set by the main memory system 190 and the second physical address PBA2 corresponding to the second storage region 1202 are mapped to each other.

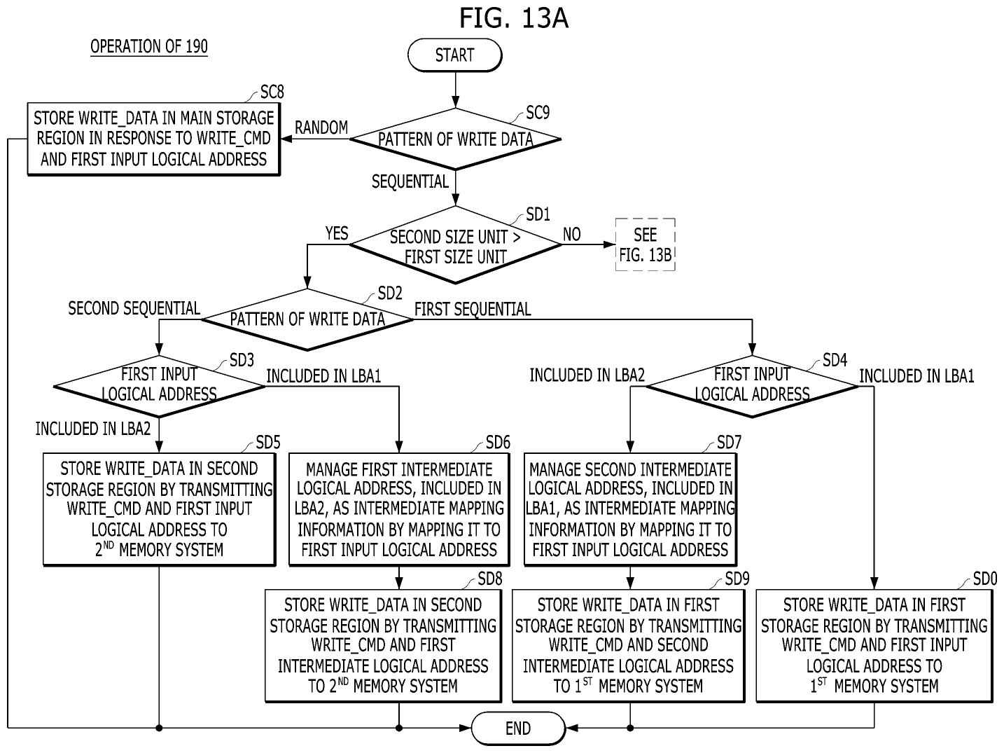

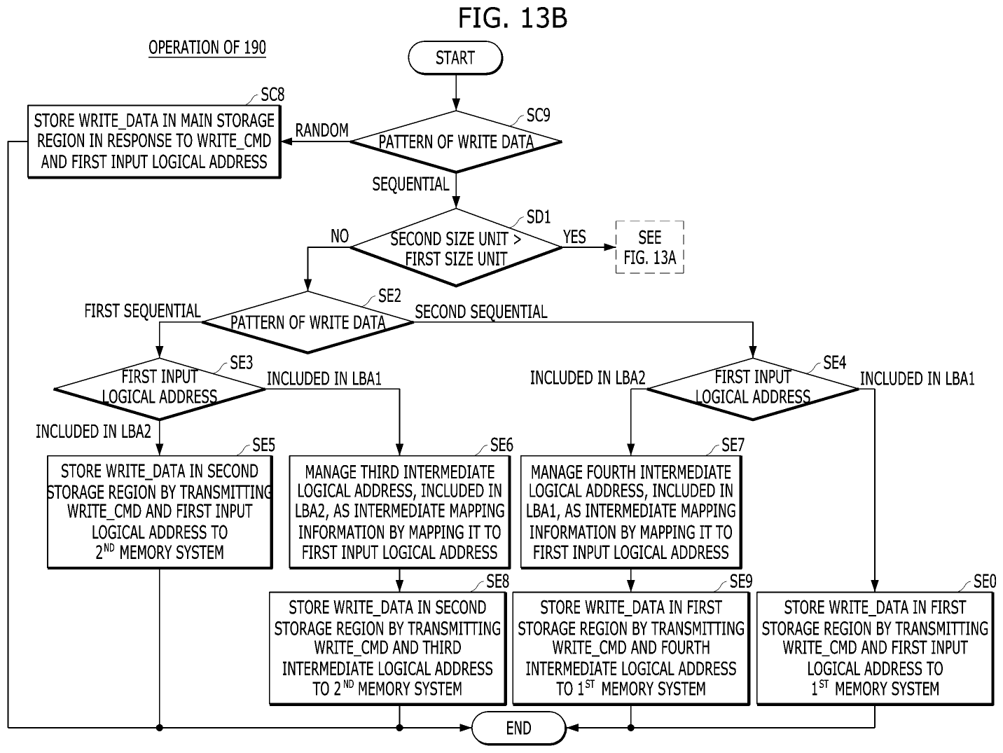

FIGS. 13A and 13B illustrate an example of a command processing operation based on logical addresses in the data processing system 100 in accordance with an embodiment of the present disclosure.

Referring to FIGS. 13A and 13B, a write command processing operation of the command processing operation based on logical addresses in the data processing system 100 is described in detail. Namely, in addition to the operation of processing the write command WRITE_CMD described above with reference to FIGS. 9B and 10, an operation of processing a write command WRITE_CMD based on logical addresses is described in detail.

Referring to FIG. 13A, the second storage region 1202 included in the second memory system 120 is larger than the first storage region 1102 included in the first memory system 110. In other words, the operation to be described with reference to FIG. 13A is described in the context in which a second size unit as the mapping unit of internal mapping information indicating a mapping relationship between a physical address of the second storage region 1202 and a logical address is larger than a first size unit as the mapping unit of internal mapping information indicating a mapping relationship between a physical address of the first storage region 1102 and a logical address (YES of SD1). Accordingly, in FIG. 13A, in order to store write data WRITE_DATA, identified as the second sequential pattern having a size larger than the second reference size, in the second storage region 1202, the main memory system 190 may transfer the write command WRITE_CMD, corresponding to the write data WRITE_DATA identified as the second sequential pattern, to the second memory system 120 to allow the second memory system 120 to process the write command WRITE_CMD. Further, in FIG. 13A, in order to store write data WRITE_DATA, identified as the first sequential pattern having a size smaller than the second reference size and larger than the first reference size, in the first storage region 1102, the main memory system 190 may transfer the write command WRITE_CMD, corresponding to the write data WRITE_DATA identified as the first sequential pattern, to the first memory system 110 to allow the first memory system 110 to process the write command WRITE_CMD. Moreover, in FIG. 13A, in order to store write data WRITE_DATA, identified as the random pattern having a size smaller than the first reference size, in the main storage region 1902, the main memory system 190 may self-process the write command WRITE_CMD corresponding to the write data WRITE_DATA identified as the random pattern.

In detail, before comparing the second size unit and the first size unit (SD1), the main memory system 190 may check whether the write data WRITE_DATA inputted together with the write command WRITE_CMD from the host 102 is the random pattern (SC9). As a result of the operation of SC9, when the write data WRITE_DATA inputted together with the write command WRITE_CMD from the host 102 is the random pattern (RANDOM of SC9), the main memory system 190 may store the write data WRITE_DATA in the main storage region 1902 in response to the write command WRITE_CMD and a first input logical address inputted from the host 102 (SC8). In response to the write command WRITE_CMD, the main memory system 190 may map a specific physical address, indicating a specific physical region capable of storing data in the main storage region 1902, to the first input logical address, and then, may store the write data WRITE_DATA, transmitted from the host 102, in the specific physical region.

In the state in which the second size unit is set larger than the first size unit (YES of SD1), the main memory system 190 may check which pattern the write data WRITE_DATA inputted together with the write command WRITE_CMD from the host 102 has (SD2).

As a result of the operation of SD2, when the write data WRITE_DATA inputted together with the write command WRITE_CMD from the host 102 is the second sequential pattern (SECOND SEQUENTIAL of SD2), the main memory system 190 may check the value of the first input logical address inputted together with the write command WRITE_CMD (SD3).

As a result of the operation of SD3, when the value of the first input logical address inputted together with the write command WRITE_CMD is included in the range of the second logical address LBA2 managed in the second memory system 120 (INCLUDED IN LBA2 of SD3), the main memory system 190 may transmit the write command WRITE_CMD, the first input logical address and the write data WRITE_DATA, inputted from the host 102, to the second memory system 120 such that the write data WRITE_DATA can be stored in the second storage region 1202 included in the second memory system 120 (SD5). In response to the write command WRITE_CMD, the second memory system 120 may map a specific physical address, indicating a specific physical region capable of storing data in the second storage region 1202, to the first input logical address, and then, may store the write data WRITE_DATA, transmitted from the main memory system 190, in the specific physical region.

As a result of the operation of SD3, when the value of the first input logical address inputted together with the write command WRITE_CMD is included in the range of the first logical address LBA1 managed in the first memory system 110 (INCLUDED IN LBA1 of SD3), the main memory system 190 may manage a first intermediate logical address, included in the range of the second logical address LBA2 managed in the second memory system 120, as intermediate mapping information, by mapping the first intermediate logical address to the first input logical address inputted from the host 102 (SD6). The main memory system 190 may transmit the first intermediate logical address whose value is determined through the operation SD6, to the second memory system 120 together with the write command WRITE_CMD and the write data WRITE_DATA such that the write data WRITE_DATA can be stored in the second storage region 1202 included in the second memory system 120 (SD8). In response to the write command WRITE_CMD, the second memory system 120 may map a specific physical address, indicating a specific physical region capable of storing data in the second storage region 1202, to the first intermediate logical address, and then, may store the write data WRITE_DATA, transmitted from the main memory system 190, in the specific physical region.

As a result of the operation of SD2, when the write data WRITE_DATA inputted together with the write command WRITE_CMD from the host 102 is the first sequential pattern (FIRST SEQUENTIAL of SD2), the main memory system 190 may check the value of the first input logical address inputted together with the write command WRITE_CMD (SD4).

As a result of the operation of SD4, when the value of the first input logical address inputted together with the write command WRITE_CMD is included in the range of the second logical address LBA2 managed in the second memory system 120 (INCLUDED IN LBA2 of SD4), the main memory system 190 may manage a second intermediate logical address, included in the range of the first logical address LBA1 managed in the first memory system 110, as the intermediate mapping information, by mapping the second intermediate logical address to the first input logical address inputted from the host 102 (SD7). The main memory system 190 may transmit the second intermediate logical address whose value is determined through the operation SD7, to the first memory system 110 together with the write command WRITE_CMD and the write data WRITE_DATA such that the write data WRITE_DATA can be stored in the first storage region 1102 included in the first memory system 110 (SD9). In response to the write command WRITE_CMD, the first memory system 110 may map a specific physical address, indicating a specific physical region capable of storing data in the first storage region 1102, to the second intermediate logical address, and then, may store the write data WRITE_DATA, transmitted from the main memory system 190, in the specific physical region.

As a result of the operation of SD4, when the value of the first input logical address inputted together with the write command WRITE_CMD is included in the range of the first logical address LBA1 managed in the first memory system 110 (INCLUDED IN LBA1 of SD4), the main memory system 190 may transmit the write command WRITE_CMD, the first input logical address and the write data WRITE_DATA, inputted from the host 102, to the first memory system 110 such that the write data WRITE_DATA can be stored in the first storage region 1102 included in the first memory system 110 (SD0). In response to the write command WRITE_CMD, the first memory system 110 may map a specific physical address, indicating a specific physical region capable of storing data in the first storage region 1102, to the first input logical address, and then, may store the write data WRITE_DATA, transmitted from the main memory system 190, in the specific physical region.

Briefly, even though the first input logical address inputted together with the write command WRITE_CMD is in the range of the second logical address LBA2 managed in the second memory system 120, when the write data WRITE_DATA is stored in the first storage region 1102 depending on the pattern of the write data WRITE_DATA and a comparison of the first size unit and the second size unit, the main memory system 190 may generate and manage the intermediate mapping information to map the first input logical address in the range of the second logical address LBA2 to the second intermediate logical address in the range of the first logical address LBA1 managed in the first memory system 110.

Also, even though the first input logical address inputted together with the write command WRITE_CMD is in the range of the first logical address LBA1 managed in the first memory system 110, when the write data WRITE_DATA is stored in the second storage region 1202 in the second memory system 120 depending on the pattern of the write data WRITE_DATA and a comparison of the first size unit and the second size unit, the main memory system 190 may generate and manage the intermediate mapping information to map the first input logical address in the range of the first logical address LBA1 to the first intermediate logical address in the range of the second logical address LBA2 managed in the second memory system 120.

Referring to FIG. 13B, the second storage region 1202 included in the second memory system 120 is smaller than the first storage region 1102 included in the first memory system 110. In other words, the operation to be described with reference to FIG. 13B is described in the context in which a second size unit as the mapping unit of internal mapping information indicating a mapping relationship between a physical address of the second storage region 1202 and a logical address is smaller than a first size unit as the mapping unit of internal mapping information indicating a mapping relationship between a physical address of the first storage region 1102 and a logical address (NO of SD1). Accordingly, in FIG. 13B, in order to store write data WRITE_DATA, identified as the second sequential pattern having a size larger than the second reference size, in the first storage region 1102, the main memory system 190 may transfer the write command WRITE_CMD, corresponding to the write data WRITE_DATA identified as the second sequential pattern, to the first memory system 110 to allow the first memory system 110 to process the write command WRITE_CMD. Further, in FIG. 13B, in order to store write data WRITE_DATA, identified as the first sequential pattern having a size smaller than the second reference size and larger than the first reference size, in the second storage region 1202, the main memory system 190 may transfer the write command WRITE_CMD, corresponding to the write data WRITE_DATA identified as the first sequential pattern, to the second memory system 120 to allow the second memory system 120 to process the write command WRITE_CMD. Moreover, in FIG. 13B, in order to store write data WRITE_DATA, identified as the random pattern having a size smaller than the first reference size, in the main storage region 1902, the main memory system 190 may self-process the write command WRITE_CMD corresponding to the write data WRITE_DATA identified as the random pattern.

In detail, before comparing the second size unit and the first size unit (SD1), the main memory system 190 may check whether the write data WRITE_DATA inputted together with the write command WRITE_CMD from the host 102 is the random pattern (SC9). As a result of the operation of SC9, when the write data WRITE_DATA inputted together with the write command WRITE_CMD from the host 102 is the random pattern (RANDOM of SC9), the main memory system 190 may store the write data WRITE_DATA in the main storage region 1902 in response to the write command WRITE_CMD and a first input logical address inputted from the host 102 (SC8). In response to the write command WRITE_CMD, the main memory system 190 may map a specific physical address, indicating a specific physical region capable of storing data in the main storage region 1902, to the first input logical address, and then, may store the write data WRITE_DATA, transmitted from the host 102, in the specific physical region.

In the state in which the second size unit is set smaller than the first size unit (NO of SD1), the main memory system 190 may check which pattern the write data WRITE_DATA inputted together with the write command WRITE_CMD from the host 102 has (SE2).

As a result of the operation of SE2, when the write data WRITE_DATA inputted together with the write command WRITE_CMD from the host 102 is the first sequential pattern (FIRST SEQUENTIAL of SE2), the main memory system 190 may check the value of the first input logical address inputted together with the write command WRITE_CMD (SE3).

As a result of the operation of SE3, when the value of the first input logical address inputted together with the write command WRITE_CMD is included in the range of the second logical address LBA2 managed in the second memory system 120 (INCLUDED IN LBA2 of SE3), the main memory system 190 may transmit the write command WRITE_CMD, the first input logical address and the write data WRITE_DATA, inputted from the host 102, to the second memory system 120 such that the write data WRITE_DATA can be stored in the second storage region 1202 included in the second memory system 120 (SE5). In response to the write command WRITE_CMD, the second memory system 120 may map a specific physical address, indicating a specific physical region capable of storing data in the second storage region 1202, to the first input logical address, and then, may store the write data WRITE_DATA, transmitted from the main memory system 190, in the specific physical region.

As a result of the operation of SE3, when the value of the first input logical address inputted together with the write command WRITE_CMD is included in the range of the first logical address LBA1 managed in the first memory system 110 (INCLUDED IN LBA1 of SE3), the main memory system 190 may manage a third intermediate logical address, included in the range of the second logical address LBA2 managed in the second memory system 120, as the intermediate mapping information, by mapping the third intermediate logical address to the first input logical address inputted from the host 102 (SE6). The main memory system 190 may transmit the third intermediate logical address whose value is determined through the operation SE6, to the second memory system 120 together with the write command WRITE_CMD and the write data WRITE_DATA such that the write data WRITE_DATA can be stored in the second storage region 1202 included in the second memory system 120 (SE8). In response to the write command WRITE_CMD, the second memory system 120 may map a specific physical address, indicating a specific physical region capable of storing data in the second storage region 1202, to the third intermediate logical address, and then, may store the write data WRITE_DATA, transmitted from the main memory system 190, in the specific physical region.

As a result of the operation of SE2, when the write data WRITE_DATA inputted together with the write command WRITE_CMD from the host 102 is the second sequential pattern (SECOND SEQUENTIAL of SE2), the main memory system 190 may check the value of the first input logical address inputted together with the write command WRITE_CMD (SE4).

As a result of the operation of SE4, when the value of the first input logical address inputted together with the write command WRITE_CMD is included in the range of the second logical address LBA2 managed in the second memory system 120 (INCLUDED IN LBA2 of SD4), the main memory system 190 may manage a fourth intermediate logical address, included in the range of the first logical address LBA1 managed in the first memory system 110, as the intermediate mapping information, by mapping the fourth intermediate logical address to the first input logical address inputted from the host 102 (SE7). The main memory system 190 may transmit the fourth intermediate logical address whose value is determined through the operation SE7, to the first memory system 110 together with the write command WRITE_CMD and the write data WRITE_DATA such that the write data WRITE_DATA can be stored in the first storage region 1102 included in the first memory system 110 (SE9). In response to the write command WRITE_CMD, the first memory system 110 may map a specific physical address, indicating a specific physical region capable of storing data in the first storage region 1102, to the fourth intermediate logical address, and then, may store the write data WRITE_DATA, transmitted from the main memory system 190, in the specific physical region.

As a result of the operation of SE4, when the value of the first input logical address inputted together with the write command WRITE_CMD is included in the range of the first logical address LBA1 managed in the first memory system 110 (INCLUDED IN LBA1 of SE4), the main memory system 190 may transmit the write command WRITE_CMD, the first input logical address and the write data WRITE_DATA, inputted from the host 102, to the first memory system 110 such that the write data WRITE_DATA can be stored in the first storage region 1102 included in the first memory system 110 (SEO). In response to the write command WRITE_CMD, the first memory system 110 may map a specific physical address, indicating a specific physical region capable of storing data in the first storage region 1102, to the first input logical address, and then, may store the write data WRITE_DATA, transmitted from the main memory system 190, in the specific physical region.

Briefly, even though the first input logical address inputted together with the write command WRITE_CMD is in the range of the second logical address LBA2 managed in the second memory system 120, when the write data WRITE_DATA is stored in the first storage region 1102 depending on the pattern of the write data WRITE_DATA and a comparison of the first size unit and the second size unit, the main memory system 190 may generate and manage the intermediate mapping information to map the first input logical address in the range of the second logical address LBA2 to the third intermediate logical address in the range of the first logical address LBA1 managed in the first memory system 110.

Also, even though the first input logical address inputted together with the write command WRITE_CMD is in the range of the first logical address LBA1 managed in the first memory system 110, when the write data WRITE_DATA is stored in the second storage region 1202 included in the second memory system 120 depending on the pattern of the write data WRITE_DATA and a comparison of the first size unit and the second size unit, the main memory system 190 may generate and manage the intermediate mapping information to map the first input logical address in the range of the first logical address LBA1 to the fourth intermediate logical address in the range of the second logical address LBA2 managed in the second memory system 120.

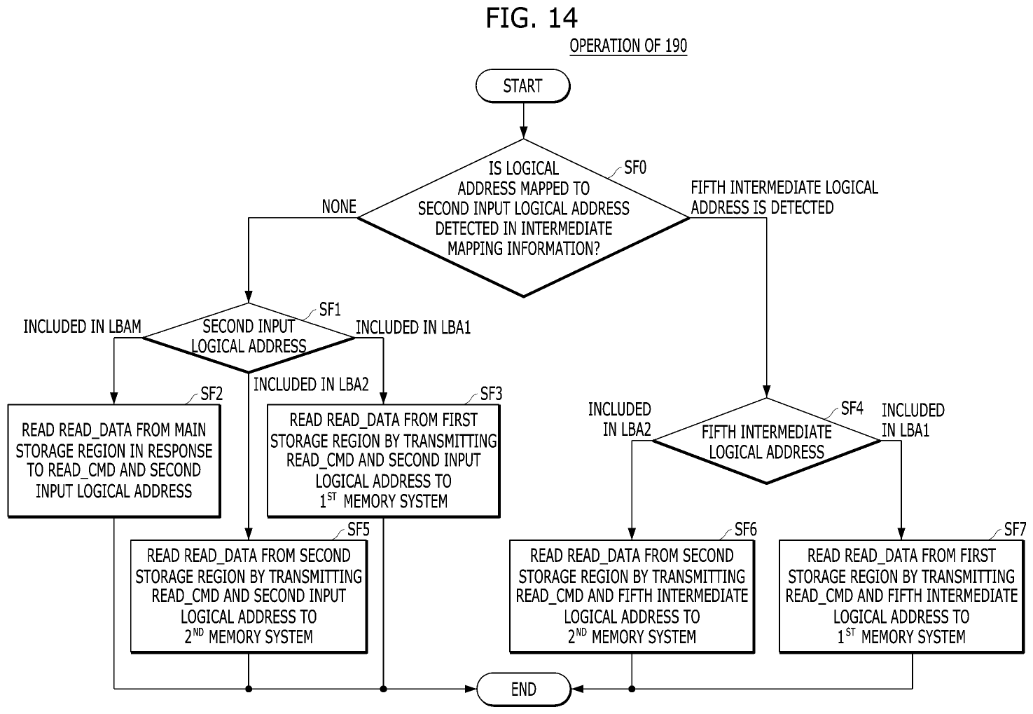

FIG. 14 illustrates another example of the command processing operation based on logical addresses in the data processing system 100 in accordance with an embodiment of the present disclosure.

Referring to FIG. 14, a read command processing operation of the command processing operation based on logical addresses in the data processing system 100 is described in detail. Namely, in addition to the operation of processing the read command READ_CMD described above with reference to FIGS. 9B and 11, an operation of processing a read command READ_CMD based on logical addresses is described in detail.

In detail, the main memory system 190 may check whether a second input logical address inputted together with the read command READ_CMD from the host 102 is detected in the intermediate mapping information (SF0).

As described above with reference to FIGS. 13A and 13B, even though the first input logical address inputted together with the write command WRITE_CMD is included in the range of the second logical address LBA2 managed in the second memory system 120, when the write data WRITE_DATA is stored in the first storage region 1102 depending on the pattern of the write data WRITE_DATA and a comparison result of the first size unit and the second size unit, the main memory system 190 may generate and manage the intermediate mapping information to map the first input logical address included in the range of the second logical address LBA2 to the intermediate logical address included in the range of the first logical address LBA1 managed in the first memory system 110.

Also, even though the first input logical address inputted together with the write command WRITE_CMD is included in the range of the first logical address LBA1 managed in the first memory system 110, when the write data WRITE_DATA is stored in the second storage region 1202 included in the second memory system 120 depending on the pattern of the write data WRITE_DATA and a comparison result of the first size unit and the second size unit, the main memory system 190 may generate and manage the intermediate mapping information to map the first input logical address included in the range of the first logical address LBA1 to the intermediate logical address included in the range of the second logical address LBA2 managed in the second memory system 120.

When a logical address mapped to the second input logical address inputted together with the read command READ_CMD from the host 102 is not detected in the intermediate mapping information (NONE of SF0), a read operation may be performed on a basis of the second input logical address.

On the contrary, when a fifth intermediate logical address mapped to the second input logical address inputted together with the read command READ_CMD from the host 102 is detected in the intermediate mapping information (FIFTH INTERMEDIATE LOGICAL ADDRESS IS DETECTED of SF0), a read operation may be performed on a basis of the fifth intermediate logical address detected in the intermediate mapping information.

As a result of the operation of SF0, when a logical address mapped to the second input logical address inputted together with the read command READ_CMD from the host 102 is not detected in the intermediate mapping information (NONE of SF0), the main memory system 190 may check the value of the second input logical address (SF1).

As a result of the operation of SF1, when the value of the second input logical address inputted together with the read command READ_CMD is included in the range of the main logical address LBAM managed in the main memory system 190 (INCLUDED IN LBAM of SF1), the main memory system 190 may read the read data READ_DATA in the main storage region 1902 in response to the read command READ_CMD and the second input logical address (SF2). The main memory system 190 may search for a specific physical address mapped to the second input logical address in the internal mapping information in response to the read command READ_CMD, and may read the read data READ_DATA in a specific physical region indicated by the specific physical address in the main storage region 1902.

As a result of the operation of SF1, when the value of the second input logical address inputted together with the read command READ_CMD is included in the range of the second logical address LBA2 managed in the second memory system 120 (INCLUDED IN LBA2 of SF1), the main memory system 190 may transmit the read command READ_CMD and the second input logical address to the second memory system 120 and thereby read read data READ_DATA in the second storage region 1202 (SF5). The second memory system 120 may search for a specific physical address mapped to the second input logical address in internal mapping information in response to the read command READ_CMD, and may read the read data READ_DATA in a specific physical region indicated by the specific physical address in the second storage region 1202.

As a result of the operation of SF1, when the value of the second input logical address inputted together with the read command READ_CMD is included in the range of the first logical address LBA1 managed in the first memory system 110 (INCLUDED IN LBA1 of SF1), the main memory system 190 may transmit the read command READ_CMD and the second input logical address to the first memory system 110 and thereby read read data READ_DATA in the first storage region 1102 (SF3). The first memory system 110 may search for a specific physical address mapped to the second input logical address in internal mapping information in response to the read command READ_CMD, and may read the read data READ_DATA in a specific physical region indicated by the specific physical address in the first storage region 1102.

As a result of the operation of SF0, when the fifth intermediate logical address mapped to the second input logical address inputted together with the read command READ_CMD from the host 102 is detected in the intermediate mapping information (FIFTH INTERMEDIATE LOGICAL ADDRESS IS DETECTED of SF0), the main memory system 190 may check the value of the fifth intermediate logical address (SF4).

As a result of the operation of SF4, when the value of the fifth intermediate logical address detected in the intermediate mapping information is included in the range of the second logical address LBA2 managed in the second memory system 120 (INCLUDED IN LBA2 of SF4), the main memory system 190 may transmit the read command READ_CMD and the fifth intermediate logical address to the second memory system 120 and thereby read the read data READ_DATA in the second storage region 1202 (SF6). The second memory system 120 may search for a specific physical address mapped to the fifth intermediate logical address in the internal mapping information in response to the read command READ_CMD, and may read the read data READ_DATA in a specific physical region indicated by the specific physical address in the second storage region 1202.

As a result of the operation of SF4, when the value of the fifth intermediate logical address detected in the intermediate mapping information is included in the range of the first logical address LBA1 managed in the first memory system 110 (INCLUDED IN LBA1 of SF4), the main memory system 190 may transmit the read command READ_CMD and the fifth intermediate logical address to the first memory system 110 and thereby read the read data READ_DATA in the first storage region 1102 (SF7). The first memory system 110 may search for a specific physical address mapped to the fifth intermediate logical address in the internal mapping information in response to the read command READ_CMD, and may read the read data READ_DATA in a specific physical region indicated by the specific physical address in the first storage region 1102.

As is apparent from the above description, by according to the second embodiment of the present disclosure, when the main, first and second memory systems 190, 110 and 120 physically separated from one another are coupled to the host 102, since the summed logical address ALL_LBA which is obtained by summing the main logical address LBAM corresponding to the main memory system 190, the first logical address LBA1 corresponding to the first memory system 110 and the second logical address LBA2 corresponding to the second memory system 120 is shared with the host 102, the host 102 may use the physically separated main, first and second memory systems 190, 110 and 120 logically like one memory system.

In addition, when the main, first and second memory systems 190, 110 and 120 physically separated from one another are coupled to the host 102, the roles of the respective main, first and second memory systems 190, 110 and 120 may be determined depending on a coupling relationship with the host 102, and, according to the determined roles, the size units and patterns of the data stored in the respective main, first and second memory systems 190, 110 and 120 may be determined differently from one another. For example, data of a random pattern having a relatively small (or the smallest) size may be stored in the main memory system 190 which is directly coupled to the host 102, first sequential data of an intermediate size may be stored in the first memory system 110 which is coupled to the host 102 through the main memory system 190, and second sequential data of a relatively large (or the largest) size may be stored in the second memory system 120 which is coupled to the host 102 through the main memory system 190. As illustrated, through this, not only may the physically separate main, first and second memory systems 190, 110 and 120 be used logically like one memory system, but also the data stored in the respective main, first and second memory systems 190, 110 and 120 may be efficiently processed.

Although various embodiments have been illustrated and described, it will be apparent to those skilled in the art that various changes and modifications may be made without departing from the spirit and scope of the invention as defined in the following claims.

1. A data processing apparatus comprising:
a first memory system including first and second interfaces and a first storage region, coupled to a host through the first interface, and configured to set a size of logical-to-physical (L2P) mapping of the first storage region to a first size unit; and
a second memory system including a third interface coupled to the second interface to communicate with the first memory system, and configured to transmit capacity information for a second storage region included therein to the first memory system according to a request of the first memory system during an initial operation period, and set a size of logical-to-physical (L2P) mapping of the second storage region to a second size unit in response to a map setting command transmitted from the first memory system during the initial operation period.

2. The data processing apparatus according to claim 1, wherein the first memory system is further configured to check the capacity information for the second storage region and set the first size unit and the second size unit, which are different from each other depending on a result of the check, during the initial operation period.

3. The data processing apparatus according to claim 2, wherein the first memory system sets the first and second size units by:
generating, when the second storage region is larger than or the same as the first storage region, the map setting command for setting the second size unit larger than the first size unit and transmitting the generated map setting command to the second memory system, and
generating, when the first storage region is larger than the second storage region, the map setting command for setting the first size unit larger than the second size unit and transmitting the generated map setting command to the second memory system.

4. The data processing apparatus according to claim 3, wherein the first memory system is further configured to:
analyze an input command received from the host during a normal operation period after the initial operation period,
select, depending on a result of the analysis, the first or second memory system to process the input command,
receive, when the second memory system is selected to process the input command, a result of processing the input command from the second memory system, and
transmit the result of processing the input command to the host.

5. The data processing apparatus according to claim 4,
wherein, when the input command is a write command, the first memory system analyzes the input command by checking a pattern of write data corresponding to the write command,
wherein, when the input command is the write command, the first memory system selects the first or second memory system by storing the write data in the first or second storage region,
wherein, when the input command is a read command, the first memory system analyzes the input command by checking a logical address corresponding to the read command, and
wherein, when the input command is the read command, the first memory system selects the first or second memory system by reading read data from the first or second storage region.

6. The data processing apparatus according to claim 5,
wherein the write data smaller than a reference size is a random pattern, and the write data larger than the reference size is of a sequential pattern,
wherein, when the second size unit is set larger than the first size unit, the first memory system stores the sequential pattern write data in the second storage region, and stores the random pattern write data in the first storage region, and
wherein, when the first size unit is set larger than the second size unit, the first memory system stores the sequential pattern write data in the first storage region, and stores the random pattern write data in the second storage region.

7. The data processing apparatus according to claim 6, wherein the first memory system is further configured to:
set a range of a first logical address corresponding to the first storage region and a range of a second logical address corresponding to the second storage region, which are different from each other during the initial operation period,
share the second logical address with the second memory system, and
share, with the host, a range of a summed logical address which is obtained by summing the ranges of the first logical address and the second logical address.

8. The data processing apparatus according to claim 7, wherein, in the case where a second input logical address corresponding to the read command is not detected in intermediate mapping information, the first memory system reads the read data from the first storage region in response to the read command and the second input logical address when the second input logical address is included in the range of the first logical address, and reads the read data by transmitting the read command and the second input logical address to the second memory system to read the read data from the second storage region when the second input logical address is included in the range of the second logical address.

9. The data processing apparatus according to claim 8, wherein, in the case in which a fifth intermediate logical address mapped to the second input logical address is detected by referring to the intermediate mapping information, the first memory system reads the read data by transmitting the read command and the fifth intermediate logical address to the second memory system to read the read data from the second storage region when the fifth intermediate logical address is included in the range of the second logical address, and reads the read data from the first storage region in response to the read command and the fifth intermediate logical address when the fifth intermediate logical address is included in the range of the first logical address.

10. The data processing apparatus according to claim 1, wherein the size of logical-to-physical (L2P) mapping of the first storage region is a size of an information representing a mapping relationship between a physical address of the first storage region and a logical address; and
wherein the size of logical-to-physical (L2P) mapping of the second storage region is a size of an information representing a mapping relationship between a physical address of the second storage region and a logical address.

11. A data processing apparatus comprising:
a main memory system including first to third interfaces and a main storage region, coupled to a host through the first interface, and configured to set a size of logical-to-physical (L2P) mapping of the main storage region to a reference size unit;
a first sub memory system including a fourth interface coupled to the second interface to communicate with the main memory system, and configured to transmit first capacity information for a first storage region included therein to the main memory system according to a request of the main memory system during an initial operation period, and set a size of logical-to-physical (L2P) mapping of the first storage region to a first size unit in response to a first map setting command transmitted from the main memory system during the initial operation period; and
a second sub memory system including a fifth interface coupled to the third interface to communicate with the main memory system, and configured to transmit second capacity information for a second storage region included therein to the main memory system according to a request of the main memory system during the initial operation period, and set a size of logical-to-physical (L2P) mapping of the second storage region to a second size unit in response to a second map setting command transmitted from the main memory system during the initial operation period.

12. The data processing apparatus according to claim 11, wherein the main memory system is further configured to compare the first and second capacity information and set the first size unit and the second size unit differently within a range larger than the reference size unit depending on a result of the comparison, during the initial operation period.

13. The data processing apparatus according to claim 12, wherein the main memory system sets the first and second size units by:
generating the first and second map setting commands for setting the first size unit larger than the second size unit and transmitting the generated first and second map setting commands to the first and second sub memory systems when the first storage region is larger than the second storage region,
generating the first and second map setting commands for setting the second size unit larger than the first size unit and transmitting the generated first and second map setting commands to the first and second sub memory systems when the second storage region is larger than the first storage region, and
generating the first and second map setting commands for setting one of the first and second size units larger than the other and transmitting the generated first and second map setting commands to the first and second sub memory systems when sizes of the first storage region and the second storage region are the same.

14. The data processing apparatus according to claim 13, wherein the main memory system is further configured to:
analyze an input command transferred from the host during a normal operation period after the initial operation period,
select, depending on a result of the analysis, the main memory system, the first sub memory system or the second sub memory system to process the input command,
receive, when the first or second sub memory system is selected to process the input command, a result of processing the input command from the selected sub memory system, and
transmit the result of processing the input command to the host.

15. The data processing apparatus according to claim 14,
wherein, when the input command is a write command, the main memory system analyzes the input command by checking a pattern of write data corresponding to the write command,
wherein, when the input command is a write command, the main memory system selects the main memory system, the first sub memory system or the second sub memory system by storing the write data in any of the main storage region, the first storage region and the second storage region,
when the input command is a read command, the main memory system analyzes the input command by checking a logical address corresponding to the read command, and
wherein, when the input command is a read command, the main memory system selects the main memory system, the first sub memory system or the second sub memory system by reading read data from any of the main storage region, the first storage region and the second storage region.

16. The data processing apparatus according to claim 15,
wherein the write data smaller than a first reference size is a random pattern and the write data larger than the first reference size is a sequential pattern,
wherein the sequential pattern write data smaller than a second reference size is a first sequential pattern, and the sequential pattern write data larger than the second reference size is a second sequential pattern,
wherein the main memory system stores the random pattern write data in the main storage region,
wherein, when the second size unit is set larger than the first size unit, the main memory system stores the first sequential pattern write data in the first storage region, and stores the second sequential pattern write data in the second storage region, and
wherein, when the first size unit is set larger than the second size unit, the main memory system stores the second sequential pattern write data in the first storage region and stores the first sequential pattern write data in the second storage region.

17. The data processing apparatus according to claim 16, wherein the main memory system is further configured to:
set a range of a main logical address corresponding to the main storage region, a range of a first logical address corresponding to the first storage region and a range of a second logical address corresponding to the second storage region differently during the initial operation period,
share the first logical address with the first sub memory system,
share the second logical address with the second sub memory system, and
share, with the host, a range of a summed logical address which is obtained by summing the ranges of the main logical address, the first logical address and the second logical address.

18. The data processing apparatus according to claim 17, wherein, in the case in which a second input logical address corresponding to the read command is not detected in intermediate mapping information, the main memory system reads the read data from the main storage region in response to the read command and the second input logical address when the second input logical address is included in the range of the main logical address, reads the read data by transmitting the read command and the second input logical address to the first sub memory system to read the read data from the first storage region when the second input logical address is included in the range of the first logical address, and reads the read data by transmitting the read command and the second input logical address to the second sub memory system to read the read data from the second storage region when the second input logical address is included in the range of the second logical address.

19. The data processing apparatus according to claim 18, wherein, in the case in which a fifth intermediate logical address mapped to the second input logical address is detected by referring to the intermediate mapping information, the main memory system reads the read data by transmitting the read command and the fifth intermediate logical address to the first sub memory system to read the read data from the first storage region when the fifth intermediate logical address is included in the range of the first logical address, and reads the read data by transmitting the read command and the fifth intermediate logical address to the second sub memory system to read the read data from the second storage region when the fifth intermediate logical address is included in the range of the second logical address.

20. The data processing apparatus according to claim 11, wherein the size of logical-to-physical (L2P) mapping of the main storage region is a size of an information representing a mapping relationship between a physical address of the main storage region and a logical address,
wherein the size of logical-to-physical (L2P) mapping of the first storage region is a size of an information representing a mapping relationship between a physical address of the first storage region and a logical address, and
wherein the size of logical-to-physical (L2P) mapping of the second storage region is a size of an information representing a mapping relationship between a physical address of the second storage region and a logical address.
